(19) United States
(12) Patent Application Publication
(10) Pub. No.: US 2025/0220360 A1
(43) Pub. Date: Jul. 3, 2025

(54) MICROPHONES

(71) Applicant: SHENZHEN SHOKZ CO., LTD., Shenzhen (CN)

(72) Inventors: Wenjun DENG, Shenzhen (CN); Yongshuai YUAN, Shenzhen (CN); Yujia HUANG, Shenzhen (CN); Wenbing ZHOU, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/079,518

(22) Filed: Mar. 14, 2025

Related U.S. Application Data
(63) Continuation of application No. PCT/CN2024/091858, filed on May 9, 2024.

(30) Foreign Application Priority Data
May 10, 2023 (CN) 202310532440.0

(51) Int. Cl. H04R 19/04; H04R 1/08; H04R 19/00

(52) U.S. Cl. CPC H04R 19/04; H04R 1/08; H04R 19/005; H04R 2410/03

(57) ABSTRACT

The present disclosure provides a capacitive microphone (100, 800, 1000) comprising a diaphragm (120) and a backplate (130). The diaphragm (120) is provided with a first hole array (121) that allows airflow to pass through, and the backplate (130) is provided with a second hole array (131) that allows airflow to pass through. The diaphragm (120) and the backplate (130) are spaced apart from each other to form a capacitor.

### CROSS-REFERENCE TO RELATED APPLICATIONS

This application is a continuation of International Application No. PCT/CN2024/091858 filed on May 9, 2024, which claims priority of Chinese Patent Application No. 202310532440.0, filed on May 10, 2023, the contents of each of which are entirely incorporated herein by reference.

### TECHNICAL FIELD

The present disclosure relates to the field of acoustics, and in particular relates to a microphone that performs acoustic-electrical conversion under an action of a viscous force of air molecules.

### BACKGROUND

With the continuous upgrading of consumer electronics, the demand for a directional microphone is increasing. The directional microphone has huge potential applications in scene recognition, sound source localization, noise reduction calls, hearing assistance, or the like. Therefore, it is desired to provide a microphone that can adjust directionality.

### SUMMARY

Some embodiments of the present disclosure provide a capacitive microphone comprising a diaphragm and a backplate. The diaphragm is provided with a first hole array that allows airflow to pass through, and the backplate is provided with a second hole array that allows airflow to pass through. The diaphragm and the backplate are spaced apart from each other to form a capacitor.

In some embodiments, a diameter of each hole of the first hole array on the diaphragm is in a range of 5 μm to 50 μm; or a diameter of each hole of the second hole array on the backplate is in a range of 5 μm to 50 μm.

In some embodiments, a spacing between two adjacent holes of the first hole array on the diaphragm is in a range of 0.1 μm to 50 μm; or a spacing between two adjacent holes of the second hole array on the backplate is in a range of 0.1 μm to 50 μm.

In some embodiments, a distance between the backplate and the diaphragm is in a range of 0.5 μm to 20 μm.

In some embodiments, a position of each hole of the first hole array on the diaphragm corresponds to a position of a hole of the second hole array on the backplate.

In some embodiments, the capacitive microphone further comprises a substrate. A perimeter side of the diaphragm is elastically connected to the substrate.

In some embodiments, the perimeter side of the diaphragm is elastically connected to the substrate through a plurality of symmetrically distributed elastic structures.

In some embodiments, a perimeter side of the backplate is rigidly connected to the substrate.

In some embodiments, a protruding structure is disposed on a surface of the backplate facing the diaphragm or a surface of the diaphragm facing the backplate.

In some embodiments, the backplate includes a conductive layer and an insulating layer, and the conductive layer is located between the insulating layer and the diaphragm.

In some embodiments, the backplate includes a conductive layer and an insulating layer, and the insulating layer is located between the conductive layer and the diaphragm.

In some embodiments, a material of the diaphragm includes at least one of polysilicon, parylene, polyimide, or metal.

In some embodiments, the backplate includes a first backplate and a second backplate disposed on two sides of the diaphragm, respectively. The diaphragm and the first backplate are spaced apart to form a first capacitor, and the diaphragm and the second backplate are spaced apart to form a second capacitor.

In some embodiments, a thickness of the diaphragm is in a range of 0.1 μm to 10 μm.

In some embodiments, a material of the insulating layer includes silicon dioxide or silicon nitride, and a material of the conductive layer includes polysilicon or metal.

In some embodiments, holes of the first hole array on the diaphragm are unevenly distributed.

In some embodiments, the capacitive microphone further comprises a housing accommodating the diaphragm and the backplate. The housing is provided with a first sound guiding hole and a second sound guiding hole. The first sound guiding hole is configured to form a first acoustic path that allows air to flow to a surface of the diaphragm facing away from the backplate, and the second sound guiding hole is configured to form a second acoustic path that allows air to flow to a surface of the diaphragm facing towards the backplate.

In some embodiments, a path length of the first acoustic path is equal to a path length of the second acoustic path.

In some embodiments, an opening area of the first sound guiding hole is equal to an opening area of the second sound guiding hole.

In some embodiments, a path length of the first acoustic path is not equal to a path length of the second acoustic path.

In some embodiments, a ratio of an absolute value of a difference between the path length of the first acoustic path and the path length of the second acoustic path to the path length of the first acoustic path is not less than 10%; or a ratio of the absolute value of the difference between the path length of the first acoustic path and the path length of the second acoustic path to the path length of the second acoustic path is not less than 10%.

In some embodiments, an area of the first sound guiding hole is not equal to an area of the second sound guiding hole.

In some embodiments, a ratio of an absolute value of a difference between the area of the first sound guiding hole and the area of the second sound guiding hole to the area of the first sound guiding hole is not less than 10%; or a ratio of the absolute value of the difference between the area of the first sound guiding hole and the area of the second sound guiding hole to the area of the second sound guiding hole is not less than 10%.

In some embodiments, the first sound guiding hole and the second sound guiding hole are respectively provided with acoustic resistance elements corresponding to different levels of acoustic resistance.

In some embodiments, an acoustic delay element is disposed in the first acoustic path and/or the second acoustic path, and the acoustic delay element is configured to extend a physical length of the corresponding acoustic path.

In some embodiments, the first acoustic path and/or the second acoustic path includes at least one bent section.

Some embodiments of the present disclosure provide a capacitive microphone, comprising: a substrate, a fixed electrode fixed on the substrate, and a movable electrode fixed on the substrate. The fixed electrode and the movable electrode are arranged opposite to each other in a first direction to form a capacitor, the movable electrode is configured to vibrate in a second direction perpendicular to the first direction, and the vibration of the movable electrode changes a facing area between the fixed electrode and the movable electrode in the first direction.

In some embodiments, the fixed electrode includes a plurality of first electrodes arranged at intervals in the first direction, and the movable electrode includes a plurality of second electrodes arranged at intervals in the first direction.

In some embodiments, an end of the movable electrode is fixed to the substrate.

In some embodiments, two ends of the movable electrode are fixed to the substrate.

In some embodiments, the movable electrode has a curved structure.

In some embodiments, a width of the curved structure is in a range of 0.1 μm to 30 μm.

In some embodiments, a thickness of the curved structure is in a range of 0.1 μm to 30 μm.

In some embodiments, the fixed electrode includes a plurality of sub-electrode layers distributed in the second direction, each pair of adjacent sub-electrode layers being separated by a sub-insulation layer.

In some embodiments, the fixed electrode includes a plurality of fixed cantilever beams, and the movable electrode includes a plurality of movable cantilever beams. The plurality of fixed cantilever beams and the plurality of movable cantilever beams are oppositely spaced apart in the first direction. An end of each of the plurality of movable cantilever beams is fixed to the substrate, and another end of each of the plurality of movable cantilever beams is connected via a connecting beam, and the connecting beam and the fixed electrode form a capacitor.

In some embodiments, the capacitive microphone further comprises a housing that accommodates the substrate, the fixed electrode, and the movable electrode. The housing is provided with a third sound guiding hole and a fourth sound guiding hole. The third sound guiding hole is configured to form a third acoustic path that allows air to flow to a surface of the movable electrode facing away from the fixed electrode, and the fourth sound guiding hole is configured to form a fourth acoustic path that allows air to flow to a surface of the movable electrode facing towards the fixed electrode.

In some embodiments, a path length of the third acoustic path is equal to a path length of the fourth acoustic path.

In some embodiments, an opening area of the third sound guiding hole is equal to an opening area of the fourth sound guiding hole.

In some embodiments, a path length of the third acoustic path is not equal to a path length of the fourth acoustic path.

In some embodiments, a ratio of an absolute value of a difference between the path length of the third acoustic path and the path length of the fourth acoustic path to the path length of the third acoustic path is not less than 10%; or a ratio of the absolute value of the difference between the path length of the third acoustic path and the path length of the fourth acoustic path to the path length of the fourth acoustic path is not less than 10%.

In some embodiments, an area of the third sound guiding hole is not equal to an area of the fourth sound guiding hole.

In some embodiments, a ratio of an absolute value of a difference between the area of the third sound guiding hole and the area of the fourth sound guiding hole to the area of the third sound guiding hole is not less than 10%; or a ratio of the absolute value of the difference between the area of the third sound guiding hole and the area of the fourth sound guiding hole to the area of the fourth sound guiding hole is not less than 10%.

In some embodiments, the third sound guiding hole and the fourth sound guiding hole are respectively provided with acoustic resistance elements corresponding to different levels of acoustic resistance.

In some embodiments, an acoustic delay element is disposed in the third acoustic path and/or the fourth acoustic path, and the acoustic delay element is configured to extend a physical length of the corresponding acoustic path.

In some embodiments, the third acoustic path and/or the fourth acoustic path includes at least one bent section.

### BRIEF DESCRIPTION OF THE DRAWINGS

FIG. 1 is a schematic diagram of an exemplary structure of a capacitive microphone according to some embodiments of the present disclosure;

FIG. 2A and FIG. 2B are schematic diagrams of responses of a capacitive microphone under the action of different angles between an incidence direction of a sound wave and a vibration direction of a diaphragm of the capacitive microphone according to some embodiments of the present disclosure;

FIG. 3 is a schematic diagram of an exemplary structure of a diaphragm elastically connected to a substrate of a capacitive microphone according to some embodiments of the present disclosure;

FIG. 4 is a schematic diagram of exemplary structures of a substrate, a backplate, and a diaphragm of a capacitive microphone according to some embodiments of the present disclosure;

FIG. 5 is a schematic diagram of exemplary structures of a substrate, a backplate, and a diaphragm of a capacitive microphone according to some embodiments of the present disclosure;

FIG. 6 is a schematic diagram of exemplary structures of a substrate, a backplate, and a diaphragm of a capacitive microphone according to some embodiments of the present disclosure;

FIG. 7 is a schematic diagram of exemplary structures of a substrate, a backplate, and a diaphragm of a capacitive microphone according to some embodiments of the present disclosure;

FIG. 8 is a schematic diagram of an exemplary structure of an exemplary capacitive microphone according to some embodiments of the present disclosure;

FIG. 9 is a schematic diagram of an exemplary structure of an exemplary capacitive microphone according to some embodiments of the present disclosure;

FIG. 10 is a schematic diagram of an exemplary structure of an exemplary microphone according to some embodiments of the present disclosure;

FIG. 11 is a schematic diagram of an exemplary structure of an exemplary microphone according to some embodiments of the present disclosure;

FIG. 12 is a schematic diagram of an exemplary structure an exemplary microphone according to some embodiments of the present disclosure;

FIG. 13 is a schematic diagram of an exemplary structure of a first movable cantilever beam and a second movable cantilever beam according to some embodiments of the present disclosure;

FIG. 14 is a schematic diagram of an exemplary structure of an exemplary capacitive microphone according to some embodiments of the present disclosure;

FIG. 15 is a schematic diagram of an exemplary structure of an exemplary capacitive microphone according to some embodiments of the present disclosure;

FIG. 16 is a schematic diagram of an exemplary structure of an exemplary capacitive microphone according to some embodiments of the present disclosure;

FIG. 17 is a schematic diagram of an exemplary structure of an exemplary capacitive microphone according to some embodiments of the present disclosure;

FIG. 18A and FIG. 18B are schematic diagrams of exemplary structures of a capacitive microphone and an acoustic path thereof according to some embodiments of the present disclosure; and

FIG. 19A and FIG. 19B are schematic diagrams of exemplary structures of a capacitive microphone and an acoustic path thereof according to some embodiments of the present disclosure.

### DETAILED DESCRIPTION

In order to more clearly illustrate the technical solution of the embodiments of the present disclosure, the drawings required to be used in the description of the embodiments are briefly described below. Obviously, the drawings in the following description are only some examples or embodiments of the present disclosure, and it is possible for those skilled in the art to apply the present disclosure to other similar scenarios according to these drawings without creative labor. Unless obviously obtained from the context or the context illustrates otherwise, same reference numerals in the drawings represent the same structures or operations.

It should be understood that the terms “system,” “device,” “unit,” and/or “module” as used herein are a way to distinguish between different components, elements, parts, sections, or assemblies at different levels. However, these words may be replaced by other expressions if other words accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Embodiments of the present disclosure describe a capacitive microphone. In some embodiments, the capacitive microphone may include a housing, a diaphragm, and a backplate. The housing has an accommodation cavity, and the diaphragm and the backplate are disposed in the accommodation cavity and spaced apart from each other. A side of the diaphragm away from the backplate forms a first cavity, and a side of the backplate away from the diaphragm forms a second cavity. The first cavity and the second cavity are acoustically connected to an exterior of the microphone. The diaphragm and the backplate form a capacitor, with the diaphragm and the backplate being two poles of the capacitor, respectively. The diaphragm may vibrate in response to an external sound signal (i.e., a sound wave), causing a distance between the diaphragm and the backplate to change, which changes the capacitance of the capacitor. A change in the capacitance of the capacitor causes a change in the amount of electricity inside the capacitor, which generates an electrical signal (containing audio information).

In some embodiments, the diaphragm may be provided with a first hole array that allows airflow to pass through, and the backplate is provided with a second hole array that allows airflow to pass through. A sound wave is propagated through the first hole array by air propagation, and due to the flow of air molecules capable of generating a viscous force, the diaphragm vibrates up and down driven by the viscous force of the air molecules, and the capacitance is changed, thereby converting the sound wave into an electrical signal. When a sound wave travels through the air and pass through the first hole array, the movement of air molecules may generate a viscous force, causing the diaphragm to vibrate up and down due to the viscous force, which results in a change in the capacitance, thereby converting the sound wave into an electrical signal. Due to the flow directions of air molecules caused by sound waves incident from different directions are different, the directions of viscous forces generated by the air molecules in different flow directions are different, and the amplitudes (i.e. displacement) generated by the diaphragm under the viscous forces in different directions are different. Correspondingly, the change in the capacitance between the diaphragm and the backplate is different, which results in electrical signals of different intensities, thus enabling directional recognition by the capacitive microphone. For example, if the sound wave propagates perpendicularly to the diaphragm, the vibration amplitude of the diaphragm is large, producing a strong electrical signal. Conversely, if the sound wave propagates parallel to the diaphragm, the vibration amplitude is small, leading to little to no vibration and a weak electrical signal. By analyzing the strength of the produced electrical signal, directional recognition of the capacitive microphone is achieved. Additionally, when there is a difference in amplitudes and/or phases of sound waves on two sides of the diaphragm, the difference may also cause air molecules to move through the first hole array, generating viscous forces that drive the diaphragm to vibrate. In such cases, the electrical signal generated by the vibration of the diaphragm can accurately reflect the differences in the sound waves reaching the two sides of the diaphragm, thus allowing for the identification of directions of sound sources.

In some embodiments, the capacitive microphone may be used for sound source localization by recognizing the direction of sound waves. By utilizing the directionality of the capacitive microphone and determining the distance of sound waves, sound source localization is achieved. In some embodiments, the direction recognition capability of the capacitive microphone on sound waves may be used for acoustic scene classification (ASC), assisting in the identification of acoustic scenes. In some embodiments, the direction recognition of the capacitive microphone may also be used for noise-reduction communication, hearing assistance, and adaptive sound settings in devices (e.g., a smartphone, an earphone, etc.), or the like.

It should be noted that the vibration of the diaphragm driven by the viscous force of air molecules may be applied to other types of microphones. For example, in an electromagnetic microphone, the diaphragm with a hole array that allows airflow to pass through vibrates in a magnetic field, cutting through magnetic lines and generating an electrical signal. The vibration amplitude (i.e., displacement) produced by the diaphragm under the influence of air molecules' viscous force in different directions varies, and accordingly, the strength of the electrical signal generated by a magnet in the magnetic field also varies. This allows for directional recognition in the electromagnetic microphone. As another example, in a piezoelectric microphone or a piezoresistive microphone, if a cantilever beam or a double-clamped beam is sufficiently long, the rigidity of the cantilever beam or double-clamped beam is relatively soft, allowing the cantilever beam or the double-clamped beam to vibrate under the influence of air molecules' viscous force.

The capacitive microphone provided in the embodiments of the present disclosure will be exemplarily described below in connection with the accompanying drawings.

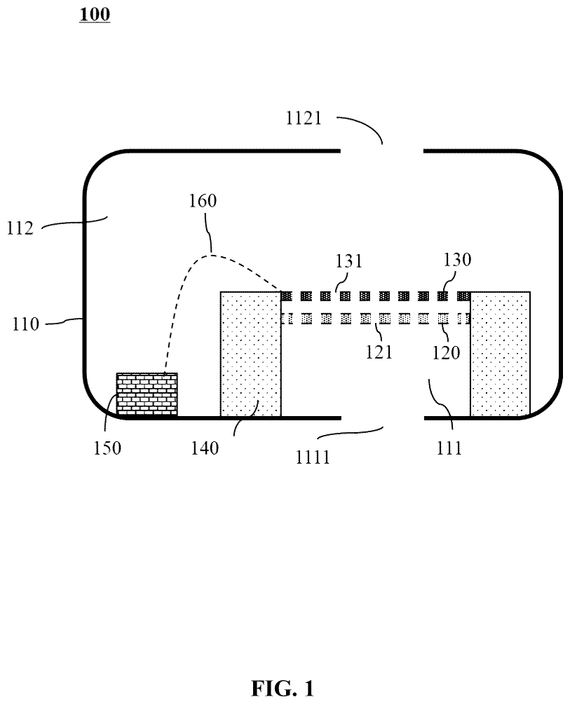

FIG. 1 is a schematic diagram of an exemplary structure of a capacitive microphone according to some embodiments of the present disclosure. As shown in FIG. 1, a capacitive microphone 100 may include a housing 110, a diaphragm 120, and a backplate 130. The interior of the housing 110 is provided with an accommodation cavity, and the diaphragm 120 and the backplate 130 are disposed in the accommodation cavity. The diaphragm 120 and the backplate 130 are disposed in the accommodation cavity and spaced apart from each other. A first cavity 111 is formed on a side of the diaphragm 120 away from the backplate 130, and a second cavity 112 is formed on a side of the backplate 130 away from the diaphragm 120. The first cavity 111 and the second cavity 112 are disposed on opposite sides of the diaphragm 120 and the backplate 130. The housing 110 is provided with a first sound guiding hole 1111 and a second sound guiding hole 1121. The first sound guiding hole 1111 is in communication with the first cavity 111, and the first cavity 111 is in acoustic communication with an exterior of the capacitive microphone 100 through the first sound guiding hole 1111. The second sound guiding hole 1121 is in communication with the second cavity 112, and the second cavity 112 is in acoustic communication with the exterior of the capacitive microphone 100 through the second sound guiding hole 1121. In some embodiments, a sound wave external to the capacitive microphone 100 may enter the second cavity 112 through the second sound guiding hole 1121, pass through the backplate 130 and the diaphragm 120, then pass through the first cavity 111, and output through the first sound guiding hole 1111. During this process, the backplate 130 and the diaphragm 120 generate an electrical signal accordingly. In some embodiments, the sound wave external to the capacitive microphone 100 may enter the first cavity 111 through the first sound guiding hole 1111, and then be output through the second sound guiding hole 1121.

The housing 110 is a three-dimensional structure having an accommodation cavity (i.e., a hollow portion). In some embodiments, the housing 110 may be a structure with a regular shape such as a cuboid, sphere, polyhedron, frustum, or any irregular shape. In some embodiments, a material of the housing 110 may include metal (e.g., stainless steel, copper, etc.), plastic (e.g., polyethylene (PE), polypropylene (PP), polyvinyl chloride (PVC), polystyrene (PS), acrylonitrile-butadiene-styrene copolymer (ABS), etc.), a composite material (e.g., a metal matrix composite material or a non-metal matrix composite material), epoxy resin, phenolic, ceramic, polyimide, glass fiber (e.g., FR4-glass fiber), or the like, or any combination thereof.

The diaphragm 120 is a device that generates vibrations in response to a sound signal. In some embodiments, the diaphragm 120 is provided with a first hole array 121 that allows airflow to pass through, and the first hole array 121 includes a plurality of micro holes distributed in arrays. Due to the viscosity generated by the movement of air molecules, the diaphragm 120 may vibrate up and down driven by a viscous force of the air molecules. The first hole array 121 on the diaphragm 120 reduces the resistance of the sound wave passing through diaphragm 120, allowing the sound wave to pass through with minimal loss. At this point, the viscous force of the air molecules has a significant impact on the diaphragm 120, which may drive the diaphragm 120 to vibrate with a relatively large vibration amplitude.

In some embodiments, in order to allow the sound wave to pass through the diaphragm 120 with less loss (i.e., a vibration speed of the air molecules in each hole is not significantly different from an external vibration speed, at this time, the viscous force of the air molecules has the greatest impact), and to ensure a sufficient contact area between the sound wave and the micro holes on the diaphragm 120, a diameter of a micro hole on the diaphragm 120 may be in a range of 5 μm-50 μm. For example, the diameter of the micro hole on the diaphragm 120 may be in a range of 10 μm-40 μm. As another example, the diameter of the micro hole on the diaphragm 120 may be in a range of 15 μm-30 μm. As yet another example, the diameter of the micro hole on the diaphragm 120 may be in a range of 20 μm-25 μm.

In some embodiments, to increase the viscous force of the air molecules on the diaphragm 120 to enable the diaphragm 120 to generate a relatively large vibration amplitude, a sufficient count of micro holes may be set on the diaphragm 120. To achieve this goal, a maximum value of a hole spacing between adjacent micro holes on the diaphragm 120 may be set within 50 μm. The hole spacing refers to a minimum distance between the edges of the adjacent micro holes. In some embodiments, if the hole spacing between the adjacent micro holes is too small, an area of an electrode formed by the diaphragm 120 may be too small, resulting in poor quality of the generated electrical signal. Therefore, a minimum value of the hole spacing between the adjacent micro holes on the diaphragm 120 may be set to be greater than 0.1 μm. In some embodiments, the hole spacing between the adjacent micro holes on the diaphragm 120 may range from 0.1 μm to 50 μm. For example, the hole spacing may be in a range of 1 μm-30 μm. As another example, the hole spacing may be in a range of 1 μm-20 μm. As yet another example, the hole spacing may be in a range of 1 μm-10 μm.

In some embodiments, the shape of the micro hole may be circular, rectangular, hexagonal, octagonal, or any other regular or irregular shape. In some embodiments, to facilitate the manufacturing of the first hole array 121 on the diaphragm 120, the micro holes of the first hole array 121 may be evenly distributed on diaphragm 120. In some embodiments, to ensure consistent vibration displacement across different parts of the diaphragm 120, the first hole array 121 may be unevenly distributed on the diaphragm 120. For example, when the peripheral side of the diaphragm 120 is relatively fixed with a fixed position of the housing 110, in order to ensure consistent vibration displacement of the entire diaphragm 120, a portion of the micro holes of the first hole array 121 may be distributed with a larger hole spacing in the middle of the diaphragm 120, while another portion of the micro holes of the first hole array 121 may be distributed with a smaller hole spacing around the periphery of diaphragm 120. In some embodiments, to facilitate the manufacturing of the first hole array 121 on the diaphragm 120, the diameters of the micro holes of the first hole array 121 may be consistent. In some embodiments, to ensure consistent vibration displacement across different parts of the diaphragm 120, the diameters of the micro holes of the first hole array 121 may be different. For example, when the peripheral side of the diaphragm 120 is relatively fixed with the fixed position of the housing 110, in order to ensure consistent vibration displacement of the entire diaphragm 120, the portion of the micro holes of the first hole array 121 positioned in the middle of the diaphragm 120 has a relatively small diameter, whereas another portion of the micro holes of the first hole array 121 around the periphery of the diaphragm 120 has a relatively large diameter.

In some embodiments, to enable the diaphragm 120 to vibrate up and down under the action of the sound wave, the thickness of the diaphragm 120 may be in a range of 0.1 μm-10 μm. For example, the thickness of the diaphragm 120 may be in a range of 0.1 μm-8 μm. As another example, the thickness of the diaphragm 120 may be in a range of 0.1 μm-5 μm. In some embodiments, the rigidity of the diaphragm 120 may be adjusted by adjusting the thickness of the diaphragm 120, thereby adjusting the sensitivity of the capacitive microphone 100. In some embodiments, the diaphragm 120 may be configured as an elastic film structure. In some embodiments, in order to make the diaphragm 120 have good elasticity and thus have a large vibration amplitude under the action of sound waves, the diaphragm 120 may be a mesh structure formed by a dense distribution of filamentous structures, where the micro holes on the diaphragm 120 may be tiny mesh holes on the mesh structure.

In some embodiments, the material of the diaphragm 120 may include a conductive material (e.g., copper, aluminum, graphite, sputtered gold, platinum, aluminum, etc.). In some embodiments, the diaphragm 120 may be configured as a non-conductive polymer elastic film, with at least one side coated with a conductive layer (e.g., an aluminum film layer). Exemplarily, the material of the polymer elastic film may include, but is not limited to, one or more of polyethylene terephthalate (PET), polycarbonate (PC), vinyl polymer (PVC), acrylonitrile-butadiene-styrene copolymer (ABS), polyethylene (PE), polyethylene terephthalate (Parylene), and polyimide (PI). In some embodiments, the diaphragm 120 may be configured as a composite film structure composed of a conductive layer and a non-conductive polymer structural layer. The conductive layer may include a sputtered metal (e.g., gold, platinum, aluminum, etc.), and the non-conductive polymer structural layer may be made from polymer materials such as Parylene, polyimide (PI), or the like. In some embodiments, the material of the diaphragm 120 may include silicon, silicon oxide, silicon nitride, silicon carbide, plastic material, resin material, or the like, or any combination thereof. In some embodiments, the diaphragm 120 may be made entirely of conductive polysilicon.

The backplate 130 may be disposed in the housing 110, and the vibration of the diaphragm 120 with respect to the backplate 130 may result in a change in capacitance between the diaphragm 120 and the backplate 130, and a corresponding change in the generated electrical signal. Optionally, the backplate 130 may be provided substantially stationary and unmoving in the housing 110, that is to say, a shape and a position of the backplate 130 with respect to the housing 110 remains substantially unchanged as the airflow passes through. In this case, the change in capacitance between the diaphragm 120 and the backplate 130 mainly originates from the deformation or vibration of the diaphragm 120 under the influence of the airflow. Optionally, the backplate 130 may vibrate relative to the housing 110 as the airflow passes through. For example, the backplate 130 and the diaphragm 120 may have different stiffnesses, creating asynchronous deformation and vibration as the airflow passes through. In this case, the change in capacitance between the diaphragm 120 and the backplate 130 arises primarily from a difference in vibration between the diaphragm 120 and the backplate 130. The difference in stiffness between the backplate 130 and the diaphragm 120 may be realized by using different materials or different structures. In some embodiments, the backplate 130 may be provided with one or more holes that allow the sound wave to pass through the backplate 130. In some embodiments, the backplate 130 is provided with a second hole array 131 that allows airflow to pass through the backplate 130. The second hole array 131 may include a plurality of micro holes distributed in an array. The micro holes of the second hole array 131 are similar to the micro holes of the first hole array 121 and are not described herein. In some embodiments, the micro holes on the backplate 130 correspond one-to-one with the micro holes on the diaphragm 120, which facilitates direct passage of the sound wave through the backplate 130 and the diaphragm 120, thereby minimizing loss of the sound wave. It should be understood that “one-to-one correspondence” means that each micro hole on the diaphragm 120 has a corresponding micro hole on the backplate 130, projections of the two corresponding micro holes along a vibration direction of the diaphragm 120 are at least partially overlapping, and the sound wave may pass through the micro holes corresponding to the overlapping part. In some embodiments, in order to minimize the loss of the sound wave passing through the backplate 130 and the diaphragm 120, and to ensure that there is a sufficiently orthogonal area between the backplate 130 and the diaphragm 120, positions of the micro holes on backplate 130 correspond one-to-one with positions of the micro holes on diaphragm 120. For example, when the micro holes on the backplate 130 and the micro holes on the diaphragm 120 are positioned one-to-one and areas of the two micro holes corresponding to each other are the same, the loss of the sound wave passing through the backplate 130 and the diaphragm 120 is relatively small (negligible), the displacement of the vibration of the diaphragm 120 is maximized, and it is also ensured that there is a sufficient orthogonal area between the backplate 130 and the diaphragm 120.

In some embodiments, the backplate 130 may be disposed approximately parallel to the diaphragm 120. In some embodiments, the backplate 130 is spaced apart from the diaphragm 120, with an air domain between them. In some embodiments, after a sound wave enters the air domain passing through the backplate 130 or the diaphragm 120, the narrow air domain is conducive to generating a large air viscous force to drive the diaphragm 120 to vibrate, and at the same time, in order to avoid contact between the diaphragm 120 and the backplate 130 during the vibration process of the diaphragm 120, a distance between the backplate 130 and the diaphragm 120 may be in a range of 0.5 μm-20 μm. For example, the distance between the backplate 130 and the diaphragm 120 may be in a range of 1 μm-15 μm. As another example, the distance between the backplate 130 and the diaphragm 120 may be in a range of 2 μm-10 μm.

In some embodiments, a spacer may be provided between the backplate 130 and the diaphragm 120 to set the backplate 130 and the diaphragm 120 apart. In some embodiments, to prevent contact between the diaphragm 120 and the backplate 130 during vibration, a protruding structure may be provided on a side of the diaphragm 120 near the backplate 130. Alternatively, a protruding structure may be provided on a side of the backplate 130 near the diaphragm 120. The protruding structure acts as a stopping point, which can effectively prevent the vibrating diaphragm 120 from contacting or adhering to the backplate 130.

In some embodiments, a material of the backplate 130 may include a conductive material. In some embodiments, the material of the backplate 130 may include polysilicon and silicon nitride or any other suitable material (e.g., silicon oxide, silicon, ceramic, etc.).

The backplate 130 and the diaphragm 120 form a parallel plate capacitor. Sound waves propagate through the air and pass through the backplate 130 or diaphragm 120. Due to the flow directions of air molecules caused by sound waves incident from different directions are different, the directions of viscous forces generated by the air molecules in different flow directions are different, and the amplitudes (i.e. displacement) generated by the diaphragm 120 under the viscous forces in different directions are different. Correspondingly, the change in the capacitance between the diaphragm 120 and the backplate 130 is different, which results in electrical signals of different intensities, thus enabling directional recognition by the capacitive microphone 100. When a sound wave is incident on the diaphragm 120 perpendicularly since the sound wave is a longitudinal wave with a molecular vibration direction consistent with a sound propagation direction, an incident perpendicular wave results in a vibration direction of air being perpendicular to the diaphragm 120, which can generate a relatively large velocity difference between the air and the diaphragm 120. The velocity difference may be converted to viscous force, thereby causing a relatively great vibration of the diaphragm 120. When the incident direction of the sound wave is parallel to the diaphragm 120, the vibration of the air molecules in a perpendicular direction of the diaphragm is minimal, thus causing a relatively small vibration of the diaphragm 120. Therefore, the capacitive microphone 100 exhibits excellent directionality.

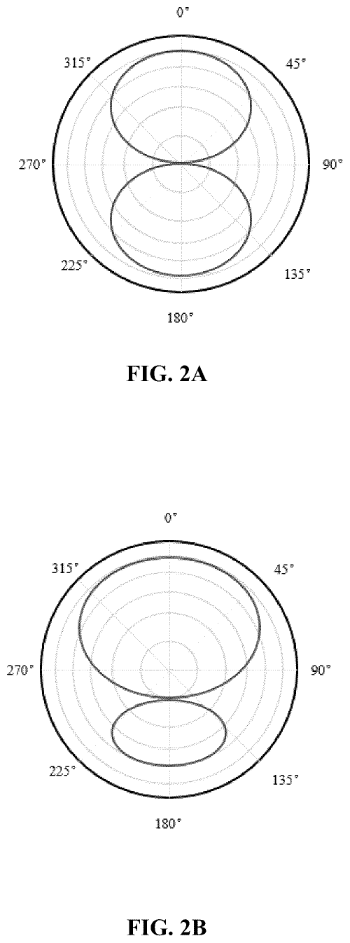

FIG. 2A and FIG. 2B are schematic diagrams of responses of a capacitive microphone under the action of different angles between an incidence direction of a sound wave and a vibration direction of a diaphragm of the capacitive microphone according to some embodiments of the present disclosure. As shown in FIGS. 2A and 2B, the capacitive microphone 100 has the weakest electrical signal (i.e., a worst acoustic response) when the angle between the incidence direction of the sound wave and the vibration direction of the diaphragm 120 is 90° or 270° (i.e., when the incidence direction of the sound wave is parallel to the diaphragm 120). In contrast, the capacitive microphone 100 has the strongest electrical signal (i.e., the best acoustic response) when the angle between the incidence direction of the sound wave and the vibration direction of the diaphragm 120 is 0° or 180° (i.e., when the incidence direction of the sound wave is perpendicular to the diaphragm 120).

Merely by way of example, the capacitive microphone 100 may have uniform directionality in both 0° and 180° directions. Referring to FIGS. 1 and 2A, through the structural design of the capacitor microphone 100, the diaphragm 120 may have a maximum sensitivity to the sound wave from a direction (0°) of the second sound guiding hole 1121 and a similar sensitivity to the sound wave from a direction (180°) of the first sound guiding hole 1111. The diaphragm 120 has a minimal sensitivity to the sound wave from directions (90° or 270°) perpendicular to its vibration direction. At this time, the sensitivity of the diaphragm 120 to sound waves from different directions forms an “8” pattern. In other words, the vibration of the diaphragm 120 is mainly generated by sound sources in the direction of 0° (or 180°) and its vicinity, and the diaphragm 120 mainly picks up sound originating from these directions, thereby rendering the capacitive microphone 100 directional.

As yet another example, the capacitive microphone 100 may have a greater directionality in one of the directions 0° and 180°. Referring to FIGS. 1 and 2B, by structurally designing the capacitive microphone 100, the sensitivity of the diaphragm 120 to sound waves from the direction (0°) of the second sound guiding hole 1121 may be greater than its sensitivity to sound waves from the direction (180°) of the first sound guiding hole 1111. At this time, the capacitor microphone 100 can better recognize sounds from the 0° and nearby directions.

In some embodiments, the magnitude of the viscous force of air molecules entering through a sound guiding hole on the diaphragm 120 may be related to a flow volume and/or a flow path (e.g., an acoustic path and a physical path) of air molecules corresponding to the sound guiding hole. For example, the greater the flow volume of the air molecules corresponding to a sound guiding hole, the greater the viscous force on the diaphragm 120 by the air molecules, making the diaphragm 120 more sensitive to sound from the corresponding direction of the sound guiding hole. As another example, the longer the path length of the flow path from the sound guiding hole to the diaphragm 120, the greater a sound pressure attenuation of the sound wave, and the smaller the viscous force on the diaphragm 120 by the air molecules, making the diaphragm 120 less sensitive to sound from the corresponding direction of the sound guiding hole.

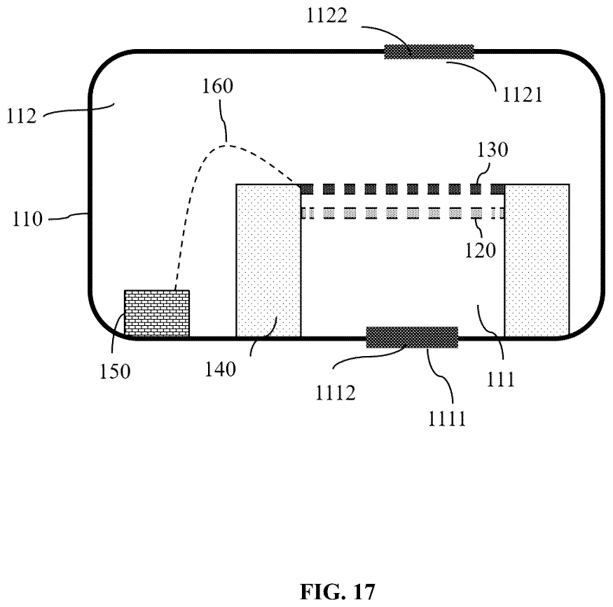

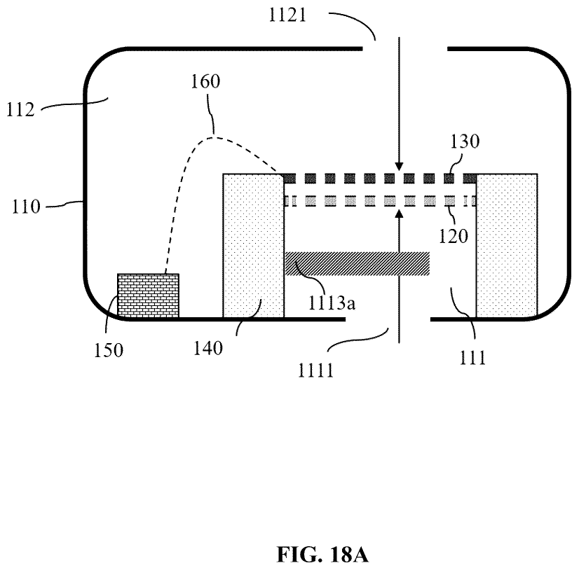

Thus, the directionality of the capacitive microphone 100 may be controlled by adjusting the flow volume and/or the flow path of the air molecules corresponding to the sound guiding holes. For example, by configuring an area of the first sound guiding hole 1111 to be equal to an area of the second sound guiding hole 1121, and their corresponding air molecules have flow paths with equal path lengths, the capacitor microphone 100 may achieve the directionality shown in FIG. 2A. For details on the equal areas of the first sound guiding hole 1111 and the second sound guiding hole 1121 and the equal path lengths of the corresponding flow paths of air molecules of the first sound guiding hole 1111 and the second sound guiding hole 1121, please refer to FIG. 15 and its related description, which will not be repeated here. Alternatively, for the directionality shown in FIG. 2B, the first sound guiding hole 1111 and the second sound guiding hole 1121 may be configured to have unequal areas or unequal path lengths of the corresponding flow paths of air molecules. For details on the unequal areas of the first sound guiding hole 1111 and the second sound guiding hole 1121 and the unequal path lengths of the corresponding flow paths of air molecules of the first sound guiding hole 1111 and the second sound guiding hole 1121, please refer to FIG. 16 and its related description, which will not be repeated here.

As shown in FIG. 1, in some embodiments, the capacitive microphone 100 may further include a substrate 140. In some embodiments, the substrate 140 may be configured as a structural body having an opening, the diaphragm 120 and the backplate 130 may be disposed at and cover the opening of the substrate 140. An end of the substrate 140 that is away from the diaphragm 120 and the backplate 130 may be connected to the housing 110 to separate the accommodation cavity into the first cavity 111 and the second cavity 112 that are disposed on opposite sides of the diaphragm 120 and the backplate 130. In some embodiments, the substrate 140 may be configured as a cylindrical structure with two through ends. One end of the cylindrical structure is connected to the housing 110 and the other end is connected to the diaphragm 120 and the backplate 130. In some embodiments, the substrate 140 may be made of a semiconductor material. The semiconductor material may include, but is not limited to, silicon dioxide, silicon nitride, gallium nitride, zinc oxide, silicon carbide, or the like.

In some embodiments, the backplate 130 and the diaphragm 120 may be physically connected to the substrate 140. The term “connected” used in the present disclosure may be understood as connecting different parts of the same structure, or connecting separate parts or structures by welding, riveting, snapping, bolting, adhesive bonding, etc., after the separate parts or structures have been prepared, or by depositing a first part or structure onto a second part or structure through physical deposition (e.g., physical vapor deposition) or chemical deposition (e.g., chemical vapor deposition) in the course of preparation.

In some embodiments, to prevent the connection between the substrate 140 and the diaphragm 120 from affecting the vibration of the diaphragm, the diaphragm 120 may be connected to the substrate 140 in a rigid or elastic manner. For example, a peripheral side of the diaphragm 120 may be elastically connected to an inner wall of the opening of the substrate 140. As another example, the peripheral side of the diaphragm 120 may be rigidly connected to the inner wall of the opening of the substrate 140. In some embodiments, a peripheral side of the backplate 130 may be rigidly or elastically connected to the inner wall of the opening of the substrate 140. For example, a side of the backplate 130 close to the substrate 140 may be rigidly connected to the end of the substrate 140 that is away from the housing 110. As another example, the side of the backplate 130 close to the substrate 140 may be elastically connected to the end of the substrate 140 that is away from the housing 110. In some embodiments, the side of the diaphragm 120 close to the substrate 140 may be elastically connected to the end of the substrate 140 that is away from the housing 110, and the peripheral side of the backplate 130 is rigidly connected to the inner wall of the opening of the substrate 140.

As shown in FIG. 1, in some embodiments, the capacitive microphone 100 may further include a processor 150. The processor 150 may be configured to process data and/or signals. In some embodiments, the processor 150 may include one or more of bipolar integrated circuits (e.g., logic gate circuits, emitter-coupled logic circuits, etc.), unipolar integrated circuits (e.g., field effect tube type integrated circuits, n-channel field effect tube integrated circuits, etc.), or the like.

In some embodiments, the processor 150 may be disposed in or at least partially suspended in the accommodation cavity of the housing 110. In some embodiments, the processor 150 may be disposed outside the accommodation cavity of the housing 110. For example, the processor 150 may be disposed on an outer surface of the housing 110, and establish a signal connection with the diaphragm 120 and the backplate 130 through a lead 160. In some embodiments, the processor 150 may process a target signal, and the processor 150 may obtain an electrical signal from the diaphragm 120 and the backplate 130 and perform signal processing.

In some embodiments, the capacitive microphone 100 may also include the lead 160. The lead 160 may be used to connect the diaphragm 120 and the backplate 130 to the processor 150. For example, the lead 160 may transmit the target signal or other signals (e.g., configuration commands, acquisition commands, etc.). In some embodiments, the lead 160 may not be required, and its function may be accomplished by other connections.

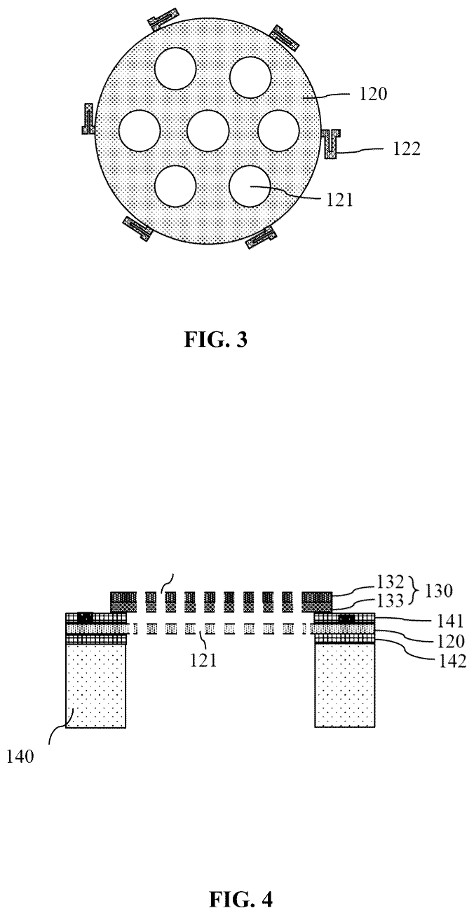

In some embodiments, the diaphragm 120 may be elastically connected to the substrate 140 in a manner as shown in FIG. 3. FIG. 3 is a schematic diagram of an exemplary structure of a diaphragm elastically connected to a substrate of a capacitive microphone according to some embodiments of the present disclosure. As shown in FIG. 3, the diaphragm 120 is elastically connected to the substrate 140 by a plurality of elastic structures 122. In some embodiments, the plurality of elastic structures 122 are symmetrically distributed along the circumference of the diaphragm 120, which results in a uniform distribution of a force on the diaphragm 120, and thus results in a better vibration consistency of the diaphragm 120 during vibration.

In some embodiments, the elastic structure 122 may be configured as a folded beam structure. In some embodiments, one of two ends of the folded beam structure is connected to the substrate 140 and the other end is fixedly connected to the diaphragm 120. In some embodiments, the elastic structure 122 may use other elastic beam structures such as a cantilever beam, a U-shaped beam, or the like. In some embodiments, the elastic structure 122 may also be configured as other structures with elasticity, such as a folded ring, a spring, a sponge pad, a silicone layer, or the like.

It should be noted that the above description of the capacitive microphone 100 is exemplary only, and does not limit the present disclosure to the scope of the cited embodiments. In some embodiments, the substrate 140 may be a structure that is not limited to being independent relative to the housing 110. In some embodiments, the substrate 140 may also be a portion of the housing 110. In yet other embodiments, the positions of the diaphragm 120 and the backplate 130 may be interchangeable, with the side of the backplate 130 away from the diaphragm 120 forming the first cavity 111 and the side of the diaphragm 120 away from the backplate 130 forming the second cavity 112.

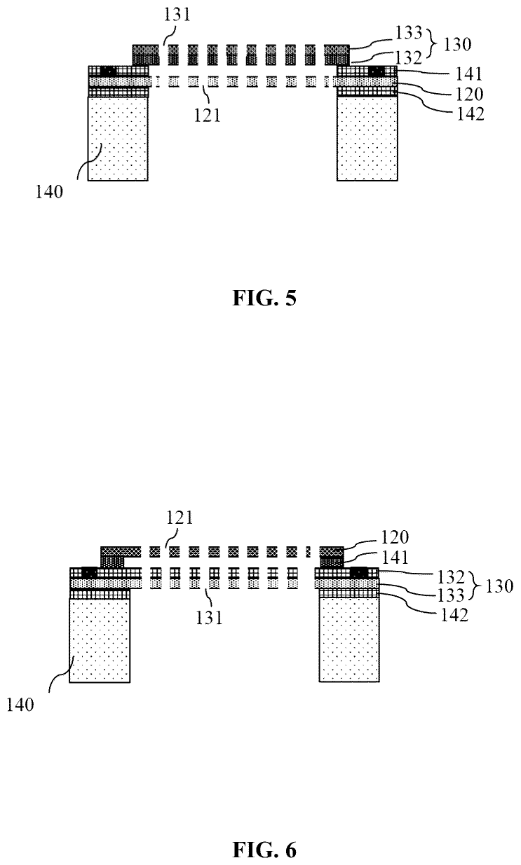

There are also a variety of ways to configure the substrate 140, the backplate 130, and the diaphragm 120 included in the capacitive microphone 100. The following exemplary illustrations of the configuration manners of the substrate 140, the backplate 130, and the diaphragm 120 are described in connection with FIG. 4-FIG. 7.

FIG. 4 is a schematic diagram of exemplary structures of a substrate 140, a backplate 130, and a diaphragm 120 of a capacitive microphone 100 according to some embodiments of the present disclosure. As shown in FIG. 4, in some embodiments, the backplate 130 may include an insulating layer 132 and a conductive layer 133. A side of the insulating layer 132 close to the substrate 140 is connected to a side of the conductive layer 133 away from the substrate 140. The second hole array 131 is provided through the insulating layer 132 and the conductive layer 133, and the conductive layer 133 is disposed between the insulating layer 132 and the diaphragm 120. The diaphragm 120 is provided with a first hole array 121, and the first hole array 121 is provided in correspondence to the second hole array 131. In some embodiments, the diaphragm 120 is spaced apart from the conductive layer by an insulating layer 141, and the insulating layer 141 forms an annular structure that does not interfere with the passage of sound waves through the backplate 130 and the diaphragm 120. In some embodiments, a side of the conductive layer 133 close to the substrate 140 is connected to a side of the insulating layer 141 away from the substrate 140, and the side of the insulating layer 141 close to the substrate 140 is connected to a side of the diaphragm 120 away from the substrate 140. In some embodiments, the diaphragm 120 is connected to the substrate 140 via an insulating layer 142, which is similar to the insulating layer 141. In some embodiments, a side of the diaphragm 120 close to the substrate 140 is connected to a side of the insulating layer 142 away from the substrate 140, and the side of the insulating layer 142 close to the substrate 140 is connected to the substrate 140.

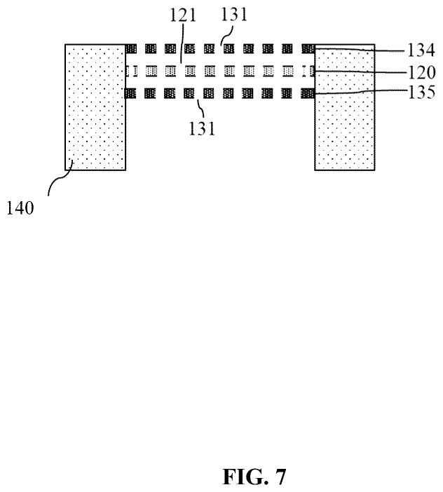

FIG. 5 is a schematic diagram of exemplary structures of a substrate 140, a backplate 130, and a diaphragm 120 of a capacitive microphone 100 according to some embodiments of the present disclosure. In some embodiments, positions of the insulating layer 132 and the conductive layer 133 included in the backplate 130 shown in FIG. 4 may be exchanged. For example, as shown in FIG. 5, a side of the conductive layer 133 close to the substrate 140 is connected to a side of the insulating layer 132 away from the substrate 140, and a side of the insulating layer 132 close to the substrate 140 is connected to a side of the insulating layer 141 away from the substrate 140.

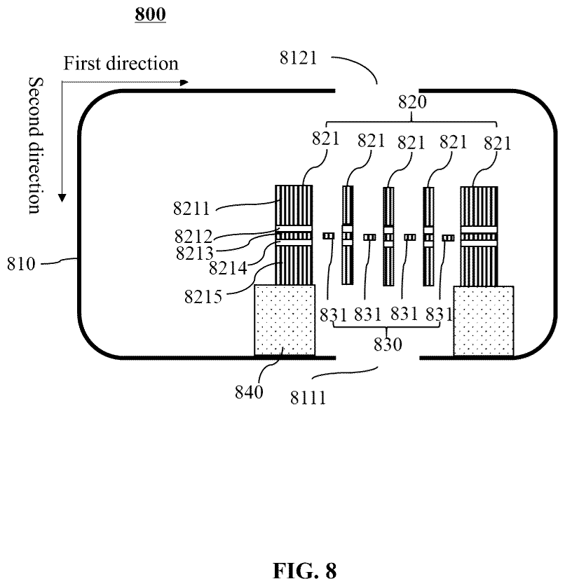

FIG. 6 is a schematic diagram of exemplary structures of a substrate 140, a backplate 130, and a diaphragm 120 of a capacitive microphone 100 according to some embodiments of the present disclosure. In some embodiments, the backplate 130 may include an insulating layer 132 and a conductive layer 133, and a position of the backplate 130 may be exchanged with a position of the diaphragm 120. For example, as shown in FIG. 6, a side of the diaphragm 120 close to the substrate 140 is connected to a side of the insulating layer 141 that is away from the substrate 140, and a side of the insulating layer 141 close to the substrate 140 is connected to a side of the insulating layer 132 away from the substrate 140. A side of the conductive layer 133 close to the substrate 140 is connected to a side of the insulating layer 142 away from the substrate 140, and a side of the insulating layer 142 close to the substrate 140 is connected to the substrate 140.

In some embodiments, the insulating layer 132, the insulating layer 141, and the insulating layer 142 are made of the same insulating material (e.g., silicon oxide or silicon nitride). For example, the insulating layer 132 is made of silicon nitride, which has a high degree of hardness and strength, making the backplate 130, which acts as a fixed electrode, less susceptible to deformation, thereby improving the reliability of the structure. In some embodiments, the conductive layer 133 may be made of a conductive material such as polysilicon or a metal (e.g., copper, aluminum, etc.).

In some embodiments, a count of the first sound guiding holes and the second sound guiding holes may be one or more. In some embodiments, the count of first sound guiding holes and the count of second sound guiding holes may be equal or unequal. For example, as shown in FIG. 1, the housing 110 may be provided with one first sound guiding hole 1111 and one second sound guiding hole 1121. As another example, the housing 110 may be provided with three first sound guiding holes 1111 and three second sound guiding holes 1121. As a further example, the housing 110 may be provided with one first sound guiding hole 1111 and two second sound guiding holes 1121.

In some embodiments, the shape of the one or more first sound guiding holes 1111 may be the same or different from the shape of the one or more second sound guiding holes 1121. For example, the shape of the one or more first sound guiding holes 1111 and the one or more second sound guiding holes 1121 may include a circular shape, a rectangular shape, a polygonal shape, an elliptical shape, an irregular shape, or the like.

In some embodiments, the first sound guiding hole and the second sound guiding hole may be disposed on opposite sides of the housing, respectively. As shown in FIG. 1, the first sound guiding hole 1111 and the second sound guiding hole 1121 are provided on a lower side and an upper side of the housing 110, respectively. The first sound guiding hole 1111 is in communication with the first cavity 111, and the first cavity 111 is in acoustic communication with an exterior of the capacitive microphone 100 through the first sound guiding hole 1111. The second sound guiding hole 1121 is in communication with the second cavity 112, and the second cavity 112 is in acoustic communication with the exterior of the capacitive microphone 100 through the second sound guiding hole 1121. In some embodiments, since the capacitive microphone 100 is sensitive to an incidence direction of the sound wave, to prevent positions of the first sound guiding hole 1111 and the second sound guiding hole 1121 from affecting the incidence direction of the sound wave, the first sound guiding hole 1111 and the second sound guiding hole 1121 may be provided directly opposite to the diaphragm 120. Directly opposite to the diaphragm 120 means that, in a plane of the backplate 130, orthogonal projections of the diaphragm 120, the first sound guiding hole 1111, and the second sound guiding hole 1121 at least partially overlap. It may be understood that positioning the first sound guiding hole and the second sound guiding hole directly opposite to the diaphragm 120 can shorten the flow path of air molecules flowing from the sound guiding hole to the diaphragm 120, thereby reducing the attenuation of sound wave pressure.

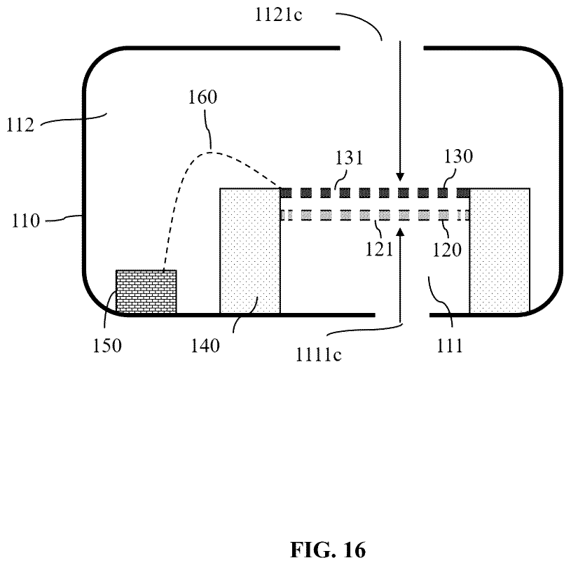

In some embodiments, the first sound guiding hole and the second sound guiding hole may be provided on a same side of the housing, such as on the same side surface of the housing. FIG. 14 is a schematic diagram of an exemplary structure of an exemplary capacitive microphone according to some embodiments of the present disclosure. As shown in FIG. 14, a lower side of the housing 110 is provided with a first sound guiding hole 1111a and a second sound guiding hole 1121a. The first sound guiding hole 1111a is in communication with the first cavity 111, and the first cavity 111 is in acoustic communication with the exterior of the capacitive microphone 100 through the first sound guiding hole 1111a. The second sound guiding hole 1121a is in communication with the second cavity 112, and the second cavity 112 is in acoustic communication with the exterior of the capacitive microphone 100 through the second sound guiding hole 1121a. At this point, a difference in amplitudes and/or phases of the acoustic pressures at the first sound guiding hole 1111a and the second sound guiding hole 1121a still results in the circulation of the airflow within the housing 110. The capacitive microphone 100 is more sensitive to sound waves originating from a direction of a line connecting the two sound guiding holes than to sound waves incident perpendicular to the lower side of the housing 110.

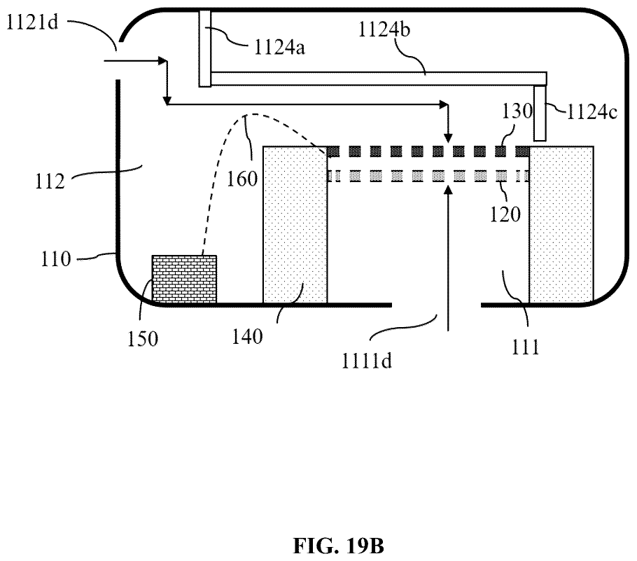

In some embodiments, the first sound guiding hole and the second sound guiding hole may be disposed on any of two sides of the housing, e.g., adjacent sides of the housing. FIG. 19B is a schematic diagram of an exemplary structure of a capacitive microphone and an acoustic path thereof according to some embodiments of the present disclosure. As shown in FIG. 19B, a first sound guiding hole 1111d and a second sound guiding hole 1121d are provided on a lower side and a left side of the housing 110, respectively. The first sound guiding hole 1111d is in communication with the first cavity 111. The first cavity 111 is in acoustic communication with the exterior of the capacitive microphone 100 through the first sound guiding hole 1111d. The second sound guiding hole 1121d is in communication with the second cavity 112, and the second cavity 112 is in acoustic communication with the exterior of the capacitive microphone 100 through the second sound guiding hole 1121d. At this point, the difference in amplitudes and/or phases of the acoustic pressures at the first sound guiding hole 1111d and the second sound guiding hole 1121d still results in the circulation of the airflow within the housing 110.

In some embodiments, flow paths (e.g., acoustic paths and physical paths) of the air molecules from different sound guiding holes to the diaphragm are different, and the flow direction of air molecules is different in the housing 110.

Merely by way of example, a sound wave external to the capacitive microphone 100 may enter the second cavity 112 through the second sound guiding hole 1121, pass through the backplate 130 and the diaphragm 120, pass through the first cavity 111, and output from the first sound guiding hole 1111. In this process, the backplate 130 and the diaphragm 120 generate an electrical signal accordingly. As another example, a sound wave external to the capacitive microphone 100 may enter the first cavity 111 through the first sound guiding hole 1111 and output from the second sound guiding hole 1121.

In some embodiments, the first sound guiding hole 1111 and the second sound guiding hole 1121 may have equal areas. When a plurality of first sound guiding holes 1111 and a plurality of second sound guiding holes 1121 are provided, the first sound guiding holes 1111 and the second sound guiding holes 1121 may have equal areas. In other words, an area of each of the first sound guiding holes 1111 is equal to an area of each of the second sound guiding holes 1121, or a sum of the areas of the plurality of first sound guiding holes 1111 is equal to a sum of the areas of the plurality of second sound guiding holes 1121. The area of the first sound guiding hole and/or the area of the second sound guiding hole refers to the smallest area of the first sound guiding hole and/or the second sound guiding hole in a cross-section that is perpendicular to an axial direction of the first sound guiding hole and/or the second sound guiding hole. FIG. 15 is a schematic diagram of an exemplary structure of an exemplary capacitive microphone according to some embodiments of the present disclosure. Referring to FIG. 15 and FIG. 2A, when it is desired that the diaphragm 120 has the same sensitivity to the flow of air molecules on the two sides of the diaphragm, i.e., the acoustic signal is in an “8” pattern, the first sound guiding hole 1111b and the second sound guiding hole 1121b may be configured to have equal areas, thereby preventing variations in area from causing different flow volumes of air molecules passing through the first sound guiding hole 1111b and the second sound guiding hole 1121b, which may further result in different sensitivities of the diaphragm 120 to the flow of air molecules on the two sides of the diaphragm.

In some embodiments, the area of the first sound guiding hole 1111 and the area of the second sound guiding hole 1121 may be different. When a plurality of first sound guiding holes 1111 and a plurality of second sound guiding holes 1121 are provided, a difference in the areas of the first sound guiding holes 1111 and the second sound guiding holes 1121 refer to the sum of the areas of the plurality of first sound guiding holes 1111 not being equal to the sum of the areas of the plurality of second sound guiding holes 1121. FIG. 16 is a schematic diagram of an exemplary structure of an exemplary capacitive microphone according to some embodiments of the present disclosure. As shown in FIG. 16, an area S1 of a first sound guiding hole 1111c may be smaller than an area S2 of a second sound guiding hole 1121c. In some embodiments of the present disclosure, the difference in the areas of the first sound guiding hole 1111 and the second sound guiding hole 1121 may allow for different flow volumes of air molecules to pass through the first sound guiding hole 1111 and the second sound guiding hole 1121, respectively, so that the diaphragm 120 has different sensitivities to the airflow coming from the 0° and 180° directions shown in FIG. 2A and FIG. 2B. For example, as shown in FIG. 16, when other variables affecting the vibration of the diaphragm 120 are the same on the two sides of the diaphragm 120, the area S1 of the first sound guiding hole 1111c is smaller than the area S2 of the second sound guiding hole 1121c, so that the flow volume of air molecules passing through the first sound guiding hole 1111c is smaller than the flow volume of air molecules passing through the second sound guiding hole 1121c. Therefore, a viscous force F2 of the air molecules on the side of the second sound guiding hole 1121c on the diaphragm 120 is larger than a viscous force F1 of the air molecules on the side of the first sound guiding hole 1111c on the diaphragm 120, i.e., the diaphragm 120 has greater sensitivity to air molecules flowing to the side of the second sound guiding hole 1121c, and the capacitive microphone 100 may exhibit the directionality shown in FIG. 2B.

In some embodiments, the directionality of the acoustic signal may be controlled by setting a difference between the area of the first sound guiding hole and the area of the second sound guiding hole. For example, the greater the difference between the area of the second sound guiding hole and the area of the first sound guiding hole, the greater the intensity of the acoustic signal pointing in the direction (0°) of the second sound guiding hole. As another example, the area of the second sound guiding hole may be set to be smaller than the area of the first sound guiding hole, so that the acoustic signal points in the direction (180°) of the first sound guiding hole. To reflect a difference in the sensitivity of the diaphragm 120 to the flow of air molecules in the two directions of 0° and 180° shown in FIG. 2A and FIG. 2B, the difference between the area of the first sound guiding hole and the area of the second sound guiding hole may reach a threshold. In some embodiments, a ratio of an absolute value of the difference between the area S1 of the first sound guiding hole 1111 and the area S2 of the second sound guiding hole 1121 to the area S1 of the first sound guiding hole 1111 is not less than 10%. For example, |S2−S1|/S1 may be in a range of 10% to 30%, e.g., 10%, 20%. As another example, |S2−S1|/S1 may be in a range of 20% to 50%, e.g., 25%, 30%, 40%, or the like. In some embodiments, a ratio of an absolute value of the difference between the area S1 of the first sound guiding hole 1111 and the area S2 of the second sound guiding hole 1121 to the area S2 of the second sound guiding hole 1121 is not less than 10%. For example, |S2−S1|/S2 may be in a range of 10% to 30%, e.g., 10%, 20%. As another example, |S2−S1|/S2 may be in a range of 20% to 50%, e.g., 25%, 30%, 40%.

In some embodiments, when it is desired for the microphone to have a uniform directionality in the 0° and 180° directions as shown in FIG. 2A, a difference between intensities of acoustic signals on the two sides of the diaphragm caused by other factors may be adjusted by setting the area of the first sound guiding hole to be different from the area of the second sound guiding hole. In some embodiments, when it is desired for the microphone to have a directionality in one of the directions of 0° and 180° as shown in FIG. 2B, the flow volumes of air molecules passing through the first sound guiding hole and the second sound guiding hole may be set to be different by setting the area of the first sound guiding hole to be different from the area of the second sound guiding hole, thereby making the viscous forces of the air molecules on the two sides of the diaphragm 120 unequal, thus adjusting the directionality of the acoustic signal.

In some embodiments, the first sound guiding hole and the second sound guiding hole are respectively provided with acoustic resistance elements corresponding to different levels of acoustic resistance. The acoustic resistance element may be an element that impedes the passage of air through the sound guiding hole. In some embodiments, the acoustic resistance element may include, but is not limited to, an acoustic resistance mesh, a waterproof member, or the like. The greater the acoustic resistance of the acoustic resistance element, the fewer air molecules that pass through it, and the lower the amplitude of the sound wave. In some embodiments, the acoustic resistance of the acoustic resistance element may be related to a structure and a material of the acoustic resistance element. For example, the smaller the porosity of the acoustic resistance mesh, the fewer air molecules that pass through it, so the greater the corresponding acoustic resistance. As another example, the greater the density and/or thickness of the material of the waterproofing member, the fewer air molecules that pass through it, thus the greater the corresponding acoustic resistance.

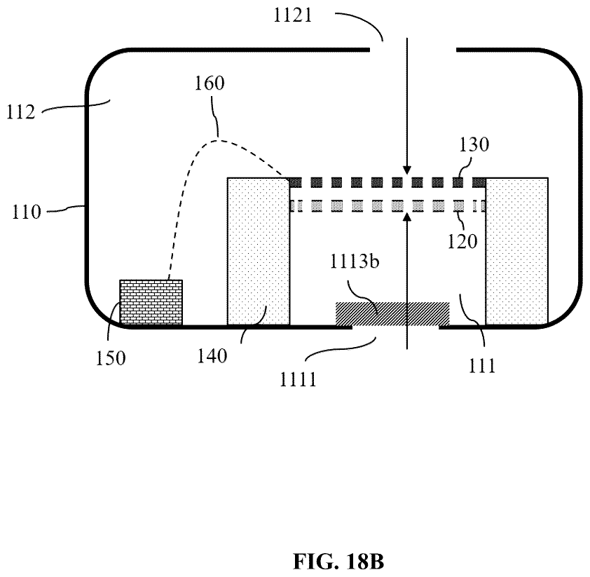

FIG. 17 is a schematic diagram of an exemplary structure of an exemplary capacitive microphone according to some embodiments of the present disclosure. Referring to FIG. 17 and FIG. 2B, merely by way of example, an acoustic resistance mesh 1112 with an acoustic resistance of R1 and an acoustic resistance mesh 1122 with an acoustic resistance of R2 may be disposed at the first sound guiding hole 1111 and the second sound guiding hole 1121, respectively. The porosity of the acoustic resistance mesh 1112 is larger than the porosity of the acoustic resistance mesh 1122, and the acoustic resistance R1 is smaller than the acoustic resistance R2, so that the acoustic resistance mesh 1112 allows more air to pass through the first sound guiding hole 1111, and the capacitive microphone 100 may exhibit the directionality shown in FIG. 2B.

In some embodiments of the present disclosure, a difference between the level of the acoustic resistance of the acoustic resistance element at the first sound guiding hole 1111 and the level of the acoustic resistance of the acoustic resistance element at the second sound guiding hole 1121 may cause the difference in the flow volume of air molecules at the first sound guiding hole 1111 and at the second sound guiding hole 1121, so that the viscous forces of the air molecules on the two sides of the diaphragm 120 are not equal, and the diaphragm 120 does not have the same sensitivity to the flow of the air molecules in the two directions of 0° and 180° shown in FIG. 2A and FIG. 2B.

In some embodiments, the magnitude and direction of the directionality of the sound wave signal may by adjusted by adjusting the difference between the level of the acoustic resistance of the acoustic resistance element at the first sound guiding hole 1111 and the level of the acoustic resistance of the acoustic resistance element at the second sound guiding hole 1121. For example, the larger the difference between the level of the acoustic resistance of the acoustic resistance element at the first sound guiding hole 1111 and the level of the acoustic resistance of the acoustic resistance element at the second sound guiding hole 1121, the more pronounced the directionality of the sound wave signal is, e.g., the larger the intensity of the sound wave signal originating from the 0° direction, as shown in FIG. 2B.

The acoustic path is a path for air to flow from the sound guiding hole to the diaphragm. In some embodiments, the acoustic path may be related to a relative position of the sound guiding hole to the diaphragm, the shape of the housing, a relative structure and position of components in the housing, or the like.

In some embodiments, the first sound guiding hole may be configured to form a first acoustic path that allows air to flow to a surface of the diaphragm facing away from the backplate, and the second sound guiding hole may be configured to form a second acoustic path that allows air to flow to a surface of the diaphragm facing towards the backplate.

The path length of the acoustic path refers to a length of an actual path of the airflow. In some embodiments, when multiple acoustic paths exist from the first sound guiding hole (or the second sound guiding hole) to the diaphragm, the shortest path of air flow from the first sound guiding hole (or the second sound guiding hole) to the diaphragm may be designated as the path length of the corresponding first acoustic path (or the second acoustic path).

In some embodiments, the path length of the first acoustic path is equal to the path length of the second acoustic path. In some embodiments, when a plurality of first sound guiding holes 1111 and a plurality of second sound guiding holes 1121 are provided, the path length of the first acoustic path may be a sum of path lengths of the plurality of first acoustic paths corresponding to the plurality of first sound guiding holes 1111, and the path length of the second acoustic path may be a sum of path lengths of the plurality of second acoustic paths corresponding to the plurality of second sound guiding holes 1121. The longer the path length of an acoustic path, the greater the attenuation of the sound pressure of the external sound wave from the corresponding sound guiding hole to the diaphragm 120. For example, as shown in FIG. 15, the first acoustic path established by the first sound guiding hole 1111b (indicated by an upward arrow in the drawing) and the second acoustic path established by the second sound guiding hole 1121b (indicated by a downward arrow in the drawing) have the same path length, such that attenuation of an acoustic pressure of an external sound wave from the first sound guiding hole 1111b to the diaphragm 120 is equal to attenuation of an acoustic pressure of an external sound wave from the second sound guiding hole 1121b to the diaphragm 120, and a phase change of the sound wave passing through the first acoustic path is equal to a phase change of the sound wave passing through the second acoustic path. The attenuation of the sound pressure of the sound wave from the sound guiding hole to the diaphragm may be viewed as the attenuation of energy of the air flowing from the sound guiding hole to the diaphragm.

Referring to FIG. 15 and FIG. 2A, when it is necessary for the diaphragm 120 to have the same sensitivity to the flow of air molecules on the two sides of the diaphragm 120, and the sound wave signal forms the “8” pattern, the path length of the first acoustic path may be configured to be equal to the path length of the second acoustic path. This configuration prevents a difference between the attenuation of energy of the air molecules from the first sound guiding hole 1111b to the diaphragm 120 and the attenuation of energy of the air molecules from the second sound guiding hole 1121b to the diaphragm 120, which may lead to different sensitivities of the diaphragm 120 to the flow of air molecules on the two sides of the diaphragm 120.

In some embodiments, the path length of the first acoustic path may be configured to be unequal to the path length of the second acoustic path. For example, as shown in FIG. 16, when other variables affecting the vibration of the diaphragm 120 are the same on the two sides of the diaphragm 120, the first acoustic path established by the first sound guiding hole 1111c may have a path length L1 that is less than a path length L2 established by the second sound guiding hole 1121c, so that the attenuation of the sound pressure of the external sound wave from the first sound guiding hole 1111c to the diaphragm 120 is less than the attenuation of the sound pressure of the external sound wave from the second sound guiding hole 1121c to the diaphragm 120, and the phase change of the sound wave passing through the first acoustic path is different from the phase change of the sound wave passing through the second acoustic path, thereby making the viscous force F1 of the air molecules on the diaphragm 120 on the side of the first sound guiding hole 1111c greater than the viscous force F2 of the air molecules on the diaphragm 120 on the side of the second sound guiding hole 1121c, i.e., the diaphragm 120 is more sensitive to the flow of air molecules originating from the side of the first sound guiding hole 1111c.

To reflect the difference in the sensitivity of the diaphragm 120 to the airflow from the 0° and 180° directions in FIGS. 2A and 2B, a difference between the path length of the first acoustic path and the path length of the second acoustic path may be set to reach a threshold. In some embodiments, a ratio of an absolute value of the difference between the path length of the first acoustic path and the path length of the second acoustic path to the path length of the first acoustic path may not be less than 10%. For example, |L2−L1|/L1 may be in a range of 10% to 30%, such as 10%, or 20%. As another example, |L2−L1|/L1 may be in a range of 20% to 50%, e.g., 25%, 30%, 40%. In some embodiments, a ratio of an absolute value of the difference between the path length of the first acoustic path and the path length of the second acoustic path to the path length of the second acoustic path is not less than 10%. For example, |L2−L1|/L2 may be in a range of 10% to 30%, such as 10%, or 20%. As another example, |L2−L1/L2 may be in a range of 20% to 50%, such as 25%, 30%, 40%, or the like.

In some embodiments, the directional magnitude and direction of the sound wave signal may be controlled by adjusting the difference between the path length of the first acoustic path and the path length of the second acoustic path. For example, the greater the difference between the path lengths of the first acoustic path and the second acoustic path, the more pronounced the directionality of the microphone's acquisition of the sound, e.g., as shown in FIG. 2B, the microphone may acquire more sounds that originate from the 0° direction. As another example, making the path length of the second acoustic path smaller than the path length of the first acoustic path allows the microphone to collect more sounds from the direction in which the second sound guiding hole is located.

In some embodiments, the path lengths of the first acoustic path and the second acoustic path may be adjusted by setting positions of the diaphragm 120 and the backplate 130 in the housing 110. Referring to FIG. 15 and FIG. 16, setting the positions of the diaphragm 120 and the backplate 130 in the housing 110 closer to the first sound guiding hole can make the path length of the first acoustic path greater than the path length of the second acoustic path.

In some embodiments, the first acoustic path and/or the second acoustic path may be lengthened by arranging an acoustic delay element in the corresponding acoustic path by extending a physical length of the corresponding acoustic path. The physical length of the acoustic path is a length of an equivalent path of air flow.

The acoustic delay element is an element that alters the phase of a sound wave. Specifically, the acoustic delay element may cause a portion of the sound waves to reflect or interfere, such that the portion of the sound waves is reflected or interfered and then passes through the sound guiding hole, thereby increasing the time for the sound waves to reach the diaphragm 120 from the sound guiding hole, and delaying the phase of the sound waves, which is equivalent to increasing the physical length of the acoustic path. For example, the acoustic delay element may be arranged only in the first acoustic path to increase the physical length of the first acoustic path. As another example, the acoustic delay element may be arranged only in the second acoustic path to increase the physical length of the second acoustic path. As a further example, acoustic delay elements with different delay effects may be arranged in the first acoustic path and the second acoustic path, respectively.

In some embodiments, the acoustic delay element may filter impurities (e.g., water, oil, dust, deposits, etc.) to avoid contamination of the microphone. In some embodiments, the acoustic delay element mitigates pressure fluctuations on the microphone due to wind noise, impact, or the like.

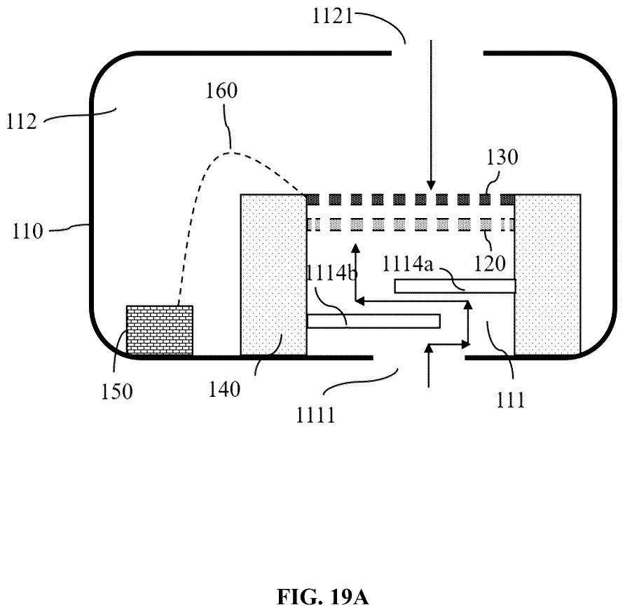

In some embodiments, the acoustic delay element may be configured as beam structure. In some embodiments, one or both of two ends of the acoustic delay element may be connected to the housing 110 or the substrate 140. FIG. 18A and FIG. 18B are schematic diagrams of exemplary structures of a capacitive microphone and an acoustic path thereof according to some embodiments of the present disclosure. As shown in FIG. 18A, an acoustic delay element 1113a may be arranged in the first acoustic path, the acoustic delay element 1113a may be a cantilever beam, and an end of the cantilever beam is connected to the substrate 140. A sound wave may be reflected on the cantilever beam as the sound wave propagates. As shown in FIG. 18B, an acoustic delay element 1113b may be arranged in the first acoustic path, and two ends of the acoustic delay element 1113b may be respectively connected to two sides of the first sound guiding hole 1111 on the housing 110. As the sound wave flows along the first acoustic path, the phase of the sound wave is delayed by the acoustic delay element 1113a (or 1113b), causing the physical length of the first acoustic path to increase.

In some embodiments of the present disclosure, when it is desired for the microphone to have a uniform directionality as shown in FIG. 2A in both the 0° and 180° directions, a difference between intensities of the sound wave signals in directions of the two sides of the diaphragm, caused by other factors, may be adjusted by arranging the acoustic delay element in the acoustic path. In other embodiments, when it is desired for the microphone to have the directionality in one of the 0° or 180° directions as shown in FIG. 2B, the directionality of the sound wave signal may be adjusted based on different delay effects of acoustic delay elements.

In some embodiments, the magnitude and direction of the directionality of the sound wave signal may be controlled by adjusting the delay effect of the acoustic delay element on the phase (e.g., by selecting acoustic delay elements made of materials with different reflection coefficients). For example, the better the delay effect of the acoustic delay elements arranged only in the first acoustic path, the longer the physical length of the first acoustic path, the more pronounced the microphone's sound collection directionality is, e.g., as shown in FIG. 2B, the microphone may collect more sounds in the 0° direction. As another example, the larger the difference between the delay effect of the acoustic delay element arranged in the first acoustic path and the delay effect of the acoustic delay element arranged in the second acoustic path, the more pronounced the microphone's sound collection directionality is.

In some embodiments, the first acoustic path and/or the second acoustic path may include at least one bent section. The bent section may be an element that changes the direction of propagation of the sound wave in the acoustic path (i.e., the direction in which the air flows in the acoustic path). Specifically, the bent section increases the actual path length of the acoustic path of the sound wave by altering the direction in which the sound wave propagates through the acoustic path such that the sound wave does not propagate along the original shortest acoustic path. FIG. 19A and FIG. 19B are schematic diagrams of exemplary structures of a capacitive microphone and an acoustic path thereof according to some embodiments of the present disclosure. For example, as shown in FIG. 19A, the bent section may be arranged only in the first acoustic path to change the propagation direction of the sound wave, thereby increasing the actual path length of the first acoustic path. As another example, as shown in FIG. 19B, the bent section may be arranged only in the second acoustic path to change the propagation direction of the sound wave, thereby increasing the actual path length of the second acoustic path. As a further example, bent sections of different shapes, counts and/or positions may be arranged in the first acoustic path and the second acoustic path, respectively, so that the path length of the actual first acoustic path and the path length of the actual second acoustic path are increased by different lengths, respectively.

In some embodiments, one or two ends of each of a plurality of bent sections may be connected to the housing 110 or the substrate 140, respectively. For example, as shown in FIG. 19A, a bent section 1114a and a bent section 1114b may be baffles with one end connected to different substrates 140, respectively. In some embodiments, one or two ends of each of the plurality of bent sections may be separately connected to each other. For example, as shown in FIG. 19B, an end of a bent section 1124a may be connected to the housing 110, another end of the bent section 1124a may be connected to an end of a bent section 1124b, and another end of the bent section 1124b may be connected to an end of the bent section 1124c.

In some embodiments of the present disclosure, when it is desired that the microphone have a uniform directionality in both the 0° and 180° directions as shown in FIG. 2A, the difference between intensities of the sound wave signals in directions of the two sides of the diaphragm, caused by other factors, may be adjusted by arranging the bent section in the acoustic path. In some embodiments, when it is desired for the microphone to have a directionality in one of the 0° or 180° directions as shown in FIG. 2B, the microphone's sound collection directionality may be adjusted based on different lengthening effects of the bent section on the acoustic path.

In some embodiments, the difference between sensitivities to the flow of air molecules on the two sides of the diaphragm 120, caused by the difference between the flow volumes of air molecules through the first sound guiding hole 1111 and the second sound guiding hole 1121, may be reduced by adjusting a difference between the physical length of the first acoustic path and the physical length of the second acoustic path. For example, when the flow volume of air molecules through the first sound guiding hole 1111 is less than the flow volume of air molecules through the second sound guiding hole 1121, and the path lengths/physical lengths of the first acoustic path and the second acoustic path are equal, the diaphragm 120 is more sensitive to airflow from the direction of the second sound guiding hole 1121, making the microphone more sensitive to sound from the direction (0°) of the second sound guiding hole 1121. In some embodiments, to make the directionality for the microphone exhibit the “8” pattern, the path length/physical length L1 of the first acoustic path may be adjusted to be shorter than the path length/physical length L2 of the second acoustic path, allowing the attenuation of the sound pressure of the external sound wave from the first sound guiding hole 1111 to the diaphragm 120 to be less than the attenuation of the sound pressure of the external sound wave from the second sound guiding hole 1121 to the diaphragm 120, so that the diaphragm 120 is equally sensitive to the flow of the air molecules on the two sides of the diaphragm 120. For example, a distance from the diaphragm 120 to the first sound guiding hole may be made shorter. As another example, the acoustic delay element may be arranged in the second acoustic path. As yet another example, the at least one bent section may be arranged in the second acoustic path.

In some embodiments, the difference between sensitivities to the flow of air molecules on the two sides of the diaphragm 120, caused by the difference between the physical length of the first acoustic path and the physical length of the second acoustic path, may be reduced by adjusting the difference between the flow volume of the air molecules through the first sound guiding hole 1111 and the flow volume of the air molecules through the second sound guiding hole 1121. For example, if the path length/physical length of the first acoustic path is greater than the path length/physical length of the second acoustic path, as well as the flow volumes of the air molecules through the first sound guiding hole 1111 and the flow volumes of the air molecules through the second sound guiding hole 1121 are equal, the diaphragm 120 is more sensitive to the flow of the air molecules originating from the side of the second sound guiding hole 1121, and the microphone may collect more sounds originating from the direction of the second sound guiding hole 1121. In some embodiments, to make the directionality for the microphone exhibit the “8” pattern, the flow volume of the air molecules through the first sound guiding hole may be adjusted to be greater than the flow volume of the air molecules through the second sound guiding hole, thereby making the diaphragm 120 equally sensitive to the flow of the air molecules on the two sides of the diaphragm 120. For example, the area of the first sound guiding hole 1111 may be increased or the area of the second sound guiding hole 1121 may be decreased. As another example, acoustic resistance elements may be arranged at the first sound guiding hole 1111 and the second sound guiding hole 1121, respectively, to make the acoustic resistance of the acoustic resistance element at the first sound guiding hole 1111 is less than the acoustic resistance of the acoustic resistance element at the second sound guiding hole 1121.

In some embodiments, the directionality of the intensity of the sound wave signal may be achieved by adjusting the difference between the path lengths/physical lengths of the first acoustic path and the second acoustic path and/or the difference between the flow volume of the air molecules through the first sound guiding hole 1111 and the flow volume of the air molecules through the second sound guiding hole 1121. For example, a microphone used for monitoring on a door should clearly receive sounds from outside the door while minimizing interference from sounds inside the door. To achieve this, the microphone's sound collection directionality may be oriented towards the outside of the door. Thus, the flow volume of the air molecules through the first sound guiding hole, which is oriented towards the inside of the door, may be reduced and/or the flow volume of the air molecules through the second sound guiding hole, which is oriented towards the outside of the door, may be increased, and/or, the length of the first acoustic path may be increased and/or the length of the second acoustic path may be decreased. For example, the area of the first sound guiding hole may be reduced and/or the area of the second sound guiding hole may be increased. As another example, the acoustic resistance of the acoustic resistance element at the first sound guiding hole may be increased. As yet another example, the acoustic delay element, the bent section, or the like may be provided in the first acoustic path.

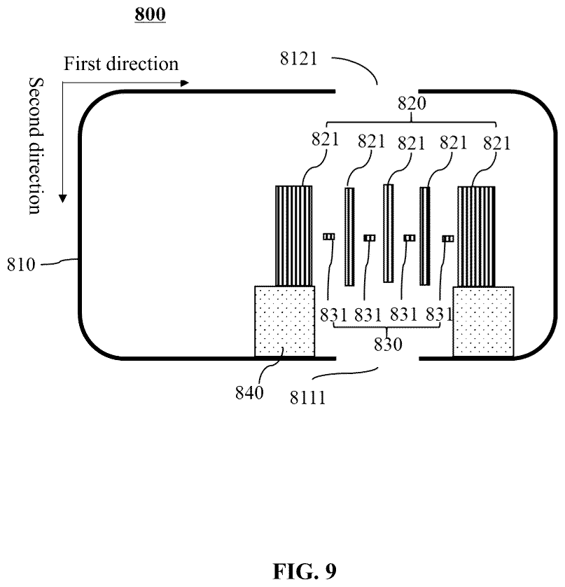

FIG. 7 is a schematic diagram of exemplary structures of a substrate 140, a backplate 130, and a diaphragm 120 of a capacitive microphone 100 according to some embodiments of the present disclosure. As shown in FIG. 7, in some embodiments, the backplate 130 may include a first backplate 134 and a second backplate 135, and the first backplate 134 and the second backplate 135 may be similar to the backplate 130 shown in FIGS. 4-6. A second hole array 131 is provided on both the first backplate 134 and the second backplate 135, and a first hole array 121 on the diaphragm 120 is provided in correspondence with the second hole array 131. The first backplate 134 and the second backplate 135 are connected to the substrate 140, the diaphragm 120 is disposed between the first backplate 134 and the second backplate 135. The first backplate 134 is spaced apart from the diaphragm 120 to form a first capacitor, and the second backplate 135 is spaced apart from the diaphragm 120 to form a second capacitor. The diaphragm 120 vibrates under an action of a sound wave, thereby causing the capacitance values of the first capacitor and the second capacitor to change. In some embodiments, the first capacitor and the second capacitor form a differential capacitor, which outputs a differential signal during operation. In some embodiments, when the diaphragm 120 vibrates toward the first backplate 134, the capacitance value of the first capacitor formed by the first backplate 134 and the diaphragm 120 increases, and the capacitance value of the second capacitor formed by the second backplate 135 and the diaphragm 120 decreases. When the diaphragm 120 vibrates toward the second backplate 135, the capacitance value of the first capacitor formed by the first backplate 134 and the diaphragm 120 decreases, and the capacitance value of the second capacitor formed by the second backplate 135 and the diaphragm 120 increases. The differential signals of the first capacitor and the second capacitor increase, and thus the sensitivity and the signal-to-noise ratio of the capacitive microphone 100 can be improved.

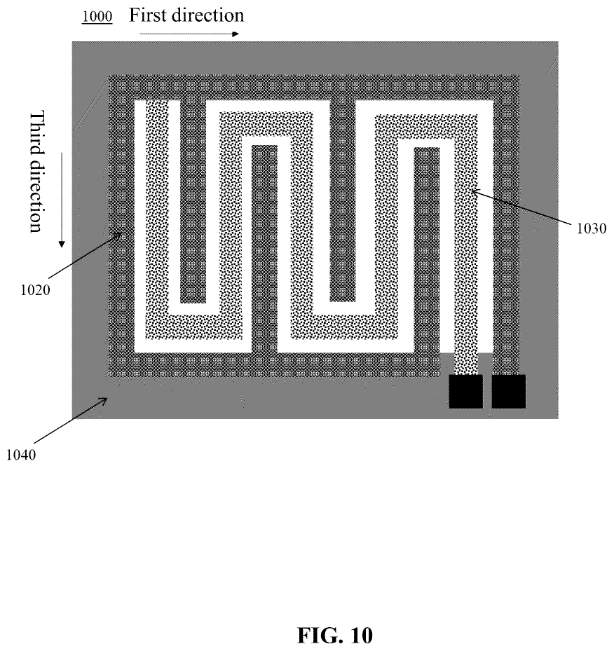

FIG. 8 is a schematic diagram of an exemplary structure of an exemplary capacitive microphone according to some embodiments of the present disclosure. As shown in FIG. 8, a capacitive microphone 800 may include a housing 810, a fixed electrode 820, a movable electrode 830, and a substrate 840. The housing 810 has an internal accommodation cavity, and the fixed electrode 820, the movable electrode 830, and the substrate 840 are disposed within the accommodation cavity. The fixed electrode 820 and the movable electrode 830 are spaced apart relative to each other in a first direction within the accommodation cavity to form a capacitor.

In some embodiments, the fixed electrode 820 is substantially immovably secured to the substrate 840, the movable electrode 830 is mounted on the substrate 840, and at least a portion of the movable electrode 830 is configured to vibrate in a second direction. In some embodiments, the second direction may be perpendicular to the first direction. In some embodiments, the vibration of the movable electrode 830 relative to the fixed electrode 820 may change a facing area between the fixed electrode 820 and the movable electrode 830 along the first direction to produce a change in capacitance. The facing area between the fixed electrode 820 and the movable electrode 830 refers to an overlapping area of projections of two opposing surfaces of the fixed electrode 820 and the movable electrode 830 along the first direction. In some embodiments, the movable electrode 830 may be configured as a single-ended fixed-supported beam structure or a double-ended fixed-supported beam structure. For example, if the movable electrode 830 is the single-ended fixed-supported beam structure, an end of the movable electrode 830 that is not fixed may be suspended and may vibrate in the second direction; if the movable electrode 830 is the double-ended fixed-supported beam structure, an overhanging portion in the middle of two fixed ends of the movable electrode 830 may vibrate in the second direction. In some embodiments, a material of the fixed electrode 820 and/or the moveable electrode 830 may be similar to the material of the diaphragm 120, which is not described herein.

In some embodiments, as shown in FIG. 8, the housing 810 is provided with a third sound guiding hole 8111 and a fourth sound guiding hole 8121 on two sides of the fixed electrode 820 and the movable electrode 830, respectively, along the second direction. In some embodiments, a sound wave external to the capacitive microphone 800 may enter the housing 810 through the fourth sound guiding hole 8121, drive the movable electrode 830 to vibrate along the second direction, and pass through gaps between the fixed electrode 820 and the movable electrode 830, and then output from the third sound guiding hole 8111. In this process, the fixed electrode 820 and the movable electrode 830 respond to generate an electrical signal. In some embodiments, the sound wave external to the capacitive microphone 800 may enter the housing 810 through the third sound guiding hole 8111, drive the movable electrode 830 to vibrate in the second direction, pass through the gaps between the fixed electrode 820 and the movable electrode 830, and then output from the fourth sound guiding hole 8121.

In some embodiments, a material, a structure, etc., of the housing 810 may be similar to the material, the structure, etc., of the housing 110 shown in FIG. 1, and a material, a structure, etc., of the substrate 840 may be similar to the material, the structure, etc., of the substrate 140 shown in FIG. 1, which will not be described herein. In some embodiments, the capacitive microphone 800 may also include the processor 150 and/or the lead 160 as shown in FIG. 1, which are not described herein.

In some embodiments, the fixed electrode 820 and the movable electrode 830 form a parallel plate capacitor. After the sound wave propagates through the sound guiding hole (the third sound guiding hole 8111 or the fourth sound guiding hole 8121) through the air, due to the flow directions of air molecules caused by sound waves incident from different directions are different, the air molecules in different flow directions cause the movable electrode 830 to vibrate along the second direction with different vibration amplitudes (i.e., displacements), correspondingly, causing the facing area between the movable electrode 830 and the fixed electrode 820 to be different, thereby causing generating different capacitances, and leading to a corresponding difference in the generated electrical signals, and enabling directional recognition by the capacitive microphone 100. When the sound wave is incident from the second direction, the air vibrates in the second direction, driving the movable electrode 830 to produce a relatively large vibration along the second direction. When the sound wave is incident from the first direction, the vibration of the air molecules in the second direction is relatively small, resulting in a relatively small vibration of the movable electrode 830 in the second direction. Therefore, the capacitive microphone 800 exhibits superior directionality.

In some embodiments, since the capacitive microphone 800 is sensitive to the incidence direction of the sound wave, to prevent the positions of the third sound guiding hole 8111 and the fourth sound guiding hole 8121 from affecting the incidence direction of the sound wave, the third sound guiding hole 8111 and the fourth sound guiding hole 8121 may be arranged at intervals directly toward the fixed electrode 820 and the movable electrode 830.

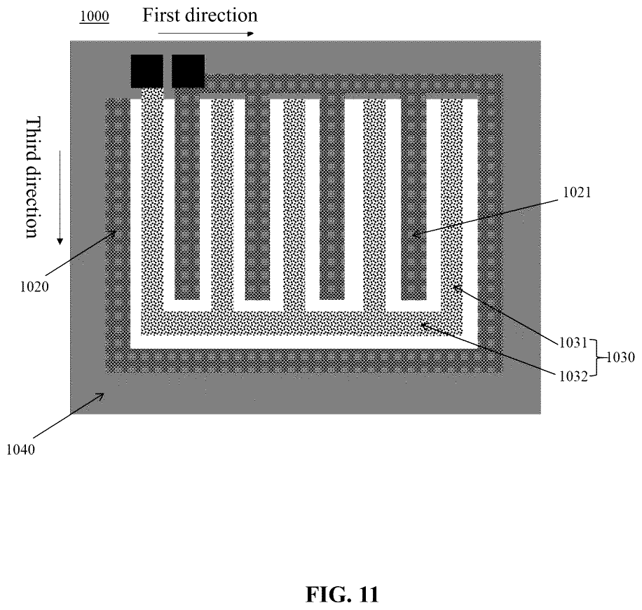

In some embodiments, the structure of the fixed electrode 820 and/or the movable electrode 830 may have different variations. For example, the fixed electrode 820 and/or the movable electrode 830 may be an integral electrode. As another example, the fixed electrode 820 and/or the movable electrode 830 may include a plurality of sub-electrodes. FIG. 9 is a schematic diagram of an exemplary structure of an exemplary capacitive microphone 800 according to some embodiments of the present disclosure. As shown in FIG. 9, the fixed electrode 820 may include a plurality of first electrodes 821 spaced apart in the first direction, and the movable electrode 830 may include a plurality of second electrodes 831 spaced apart in the first direction. In some embodiments, in order to enable the sound wave to pass through the fixed electrode 820 and the movable electrode 830 with less loss, while allowing the sound wave to have a sufficiently large contact area with the movable electrode 830, a length of a gap along the first direction between any one of the first electrodes 821 of the fixed electrode 820 and a second electrode 831 of the movable electrode 830 adjacent to that first electrode 821 may be in a range of 5 μm-50 μm. For example, the length of the gap along the first direction between each first electrode 821 and the second electrodes 831 adjacent to that first electrode 821 may be in a range of 10 μm-40 μm. As another example, the length of the gap along the first direction between each first electrode 821 and the second electrodes 831 adjacent to that first electrode 821 may be in a range of 15 μm-30 μm. As a further example, the length of the gap along the first direction between each first electrode 821 and the second electrodes 831 adjacent to that first electrode 821 may be in a range of 20 μm-25 μm.

In some embodiments, to facilitate the fabrication of the fixed electrode 820 and the movable electrode 830, the length of the gap along the first direction between each first electrode 821 and the second electrodes 831 adjacent to that first electrode 821 may be the same. In some embodiments, to achieve a consistent vibratory displacement throughout different parts of the movable electrode 830, the length of the gap along the first direction between each first electrode 821 and the second electrodes 831 adjacent to that first electrode 821 may be different. For example, when a peripheral side of the fixed electrode 820 is fixed relative to a fixed position of the housing 810, to enable the entire movable electrode 830 to have a consistent vibratory displacement, the length of the gap along the first direction between the first electrode 821 and the adjacent second electrode 831 near the substrate 840 may be less than the length of the gap along the first direction between the first electrode 821 and the adjacent second electrode 831 away from the middle position of the substrate 840.

In some embodiments, each of the plurality of first electrodes 821 may be substantially immovably secured to the substrate 840. Each of the plurality of second electrodes 831 may be configured as a single-ended fixed-supported beam structure or a double-ended fixed-supported beam structure. For example, one or two ends of each of the second electrodes 831 may be secured to the substrate 840 such that the second electrodes 831 may vibrate in the second direction.

In some embodiments, each of the first electrodes 821 of the fixed electrode 820 may include a plurality of sub-electrode layers spaced apart in the second direction, with each of two neighboring sub-electrode layers spaced apart by a sub-insulating layer. As shown in FIG. 8, each of the first electrodes 821 of the fixed electrode 820 may include a first sub-electrode layer 8211, a first sub-insulating layer 8212, a second sub-electrode layer 8213, a second sub-insulating layer 8214, and a third sub-electrode layer 8215. In some embodiments, when any one of the second electrodes 831 of the movable electrode 830 moves in the second direction, the second electrode 831 forms a first sub-capacitor with the first sub-electrode layer 8211, the second electrode 831 forms a second sub-capacitor with the second sub-electrode layer 8213, and the second electrode 831 forms a third sub-capacitor with the third sub-electrode layer 8215. The second electrode 831 vibrates under the action of the sound wave, which causes the capacitance values of the first sub-capacitor, the second sub-capacitor, and the third sub-capacitor to change. In some embodiments, a differential capacitor may be formed between any two sub-capacitors. For example, the first sub-capacitor and the second sub-capacitor form a differential capacitor that outputs a differential signal during operation. In some embodiments, when the second electrode 831 vibrates in a direction toward the first sub-electrode layer 8211, the capacitance value of the first sub-capacitor formed by the second electrode 831 and the first sub-electrode layer 8211 increases, the capacitance value of the second sub-capacitor formed by the second electrode 831 and the second sub-electrode layer 8213 decreases, and the differential signal of the first sub-capacitor and the second sub-capacitor increase, thus the sensitivity and the signal-to-noise ratio of the capacitive microphone 800 can be improved.

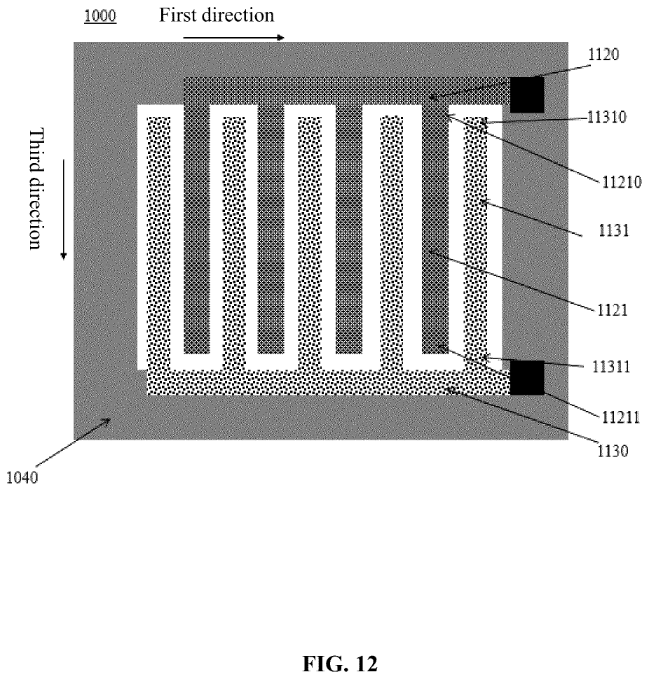

FIG. 10 is a schematic diagram of an exemplary structure of an exemplary microphone 1000 according to some embodiments of the present disclosure. The microphone 1000 shown in FIG. 10 may be the capacitive microphone as described in FIG. 8-FIG. 9 of the present disclosure, or may be another type of microphone (e.g., a piezoelectric microphone, a piezoresistive microphone, etc.). As shown in FIG. 10, the microphone 1000 may include a substrate 1040, a fixed electrode 1020, and a movable electrode 1030. In some embodiments, to increase flexibility of the movable electrode 1030 to increase a vibration amplitude (i.e., the displacement of vibration along a direction perpendicular to the paper surface) of the movable electrode 1030, a material of the movable electrode 1030 may include a relatively soft material such as plastic, resin, or the like. In some embodiments, to increase the flexibility of the movable electrode 1030 to increase the vibration amplitude (i.e., the displacement of vibration along a direction perpendicular to the paper surface) of the movable electrode 1030, the movable electrode 1030 may be configured as an electrode having a curved structure. As shown in FIG. 10, the removable electrode 1030 may be an electrode with a serpentine structure. It should be understood that the electrode with a serpentine structure shown in FIG. 10 is only an example, and the bent structure of the movable electrode 1030 may be other structures that can increase the extension length of the movable electrode 1030, for example, S-shaped, W-shaped, V-shaped, U-shaped, or the like. In some embodiments, the count of bending units in the curved structure may be in a range of 1-10. The “bending unit” refers to a connecting portion between neighboring portions of the curved structure that extend in different directions.

In some embodiments, if the removable electrode 1030 is the double-ended fixed-supported beam structure, two fixed ends of the curved structure may be on two sides of the substrate 1040, respectively, along a third direction (as shown in FIG. 10), or on a same side of the substrate 1040 along the third direction. In some embodiments, to increase the flexibility of the movable electrode 1030 to increase the vibration amplitude of the movable electrode 1030, a ratio of a total length of the curved structure to a distance between the two fixed ends along the third direction is greater than 1. In some embodiments, if the movable electrode 1030 is a single-ended fixed-supported beam structure, the fixed ends of the curved structure may be on any of the two sides of the substrate 1040 along the third direction. In some embodiments, in order to increase the flexibility of the movable electrode 1030 to increase the vibration amplitude of the movable electrode 1030, the width of the curved structure may be in a range of 0.1 μm-30 μm, and the thickness of the curved structure may be in a range of 0.1 μm-30 μm. In some embodiments, in order to avoid the deformation of the curved structure from colliding with the fixed electrode 1020, a spacing in a plane defined by the first direction and the third direction between the movable electrode 1030 and the fixed electrode 1020 can be in a range of 5 μm-50 μm. For example, a spacing between any two adjacent parts of the movable electrode 1030 and the fixed electrode 1020 in a plane defined by the first direction and the third direction may be in a range of 5 μm-50 μm.

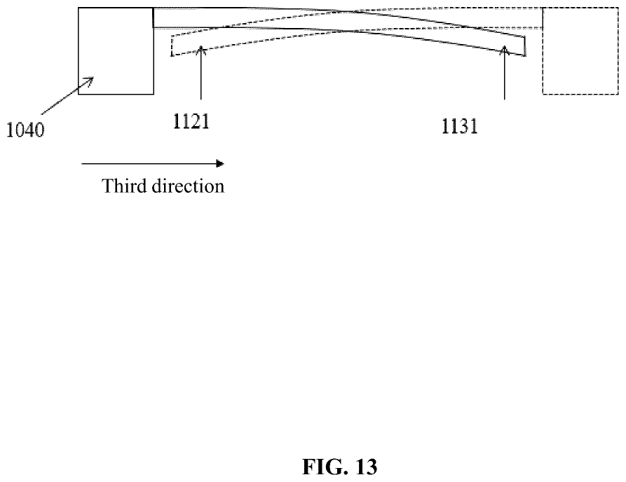

FIG. 11 is a schematic diagram of an exemplary structure of an exemplary microphone 1000 according to some embodiments of the present disclosure. The microphone 1000 shown in FIG. 11 may be the capacitive microphone as described in FIGS. 8-9 of the present disclosure, or another type of microphone (e.g., a piezoelectric microphone, a piezoresistive microphone, etc.). As shown in FIG. 11, the microphone 1000 may include a substrate 1040, a fixed electrode 1020, and a movable electrode 1030. The fixed electrode 1020 may include a plurality of fixed cantilever beams 1021. In some embodiments, the fixed cantilever beams 1021 may be substantially immovably fixed to the substrate 1040. The movable electrode 1030 may include a plurality of movable cantilever beams 1031 and a connecting beam 1032. The plurality of fixed cantilever beams 1021 may be spaced apart from the plurality of movable cantilever beams 1031 in the first direction to form capacitors. In some embodiments, an end of each of the plurality of movable cantilever beams 1031 is fixed to the substrate 1040, and another end (a free end, i.e., a non-fixed end) of each of the plurality of movable cantilever beams 1031 is connected to each other by the connecting beam 1032. Since the part with the largest vibration amplitude on each movable cantilever beam 1031 is the free end, when the free ends of the plurality of movable cantilever beams 1031 are connected via the connecting beam 1032, the vibration amplitude at the connecting beam 1032 is the largest. Therefore, compared to a situation in which the free ends are not connected by the connecting beam 1032, the free ends of the movable cantilever beams 1031, connected through the connecting beam 1032 increase the capacitance formed between the connecting beam 1032 and the fixed electrode 1020 (i.e., the plurality of fixed cantilever beams 1021), thereby enhancing the sensitivity of the microphone 1000.

In some embodiments, in order to increase the vibration amplitude at the connecting beam 1032, the material of the connecting beam 1032 may be different from the material of the plurality of movable cantilever beams 1031. For example, the elastic modulus of the material of the connecting beam 1032 may be less than the elastic modulus of the material of the plurality of movable cantilever beams 1031 to increase the vibration amplitude at the connecting beam 1032 and increase the capacitance formed between the connecting beam 1032 and the fixed electrode 1020, thereby improving the sensitivity of the microphone 1000. In some embodiments, the material of the connecting beam 1032 may be the same as the material of the plurality of movable cantilever beams 1031 to facilitate the preparation of the movable electrode 1030. For example, the material of the connecting beam 1032 may be the same as the material of the plurality of movable cantilever beams 1031 and integrally formed.

In some embodiments, to increase the flexibility of the movable electrode 1030 to increase the vibration amplitude of the movable electrode 1030, the width of the movable cantilever beam 1031 and/or the width of the connecting beam 1032 may be in a range of 0.1 μm-30 μm, and the thickness of the movable cantilever beam 1031 and/or the thickness of the connecting beam 1032 may be in a range of 0.1 μm-30 μm. In some embodiments, to allow sound to drive air molecules and further induce the vibration of the movable cantilever beams 1031 while achieving high sensitivity of the microphone 1000, the width of each of the movable cantilever beams 1031 may be the same as the width of the connecting beam 1032. In some embodiments, to prevent collision between the curved structure and the fixed electrode 1020 due to deformation, a spacing between the movable electrode 1030 (e.g., the movable cantilever beam 1031 and/or the connecting beam 1032) and the fixed electrode 1020 in a plane of the paper surface may range from 5 μm to 50 μm. For example, the spacing between any two adjacent parts of the movable electrode 1030 (e.g., the movable cantilever beam 1031 and/or the connecting beam 1032) and the fixed electrode 1020 in the plane of the paper surface may range from 5 μm to 50 μm In some embodiments, to allow sound to drive air molecules and further induce the vibration of the movable cantilever beams 1031 while achieving high sensitivity of the microphone 1000, the spacing between the movable cantilever beam 1031 and the fixed electrode 1020 in the plane of the paper surface is the same as a spacing between the connecting beam 1032 and the fixed electrode 1020 in the plane of the paper surface.

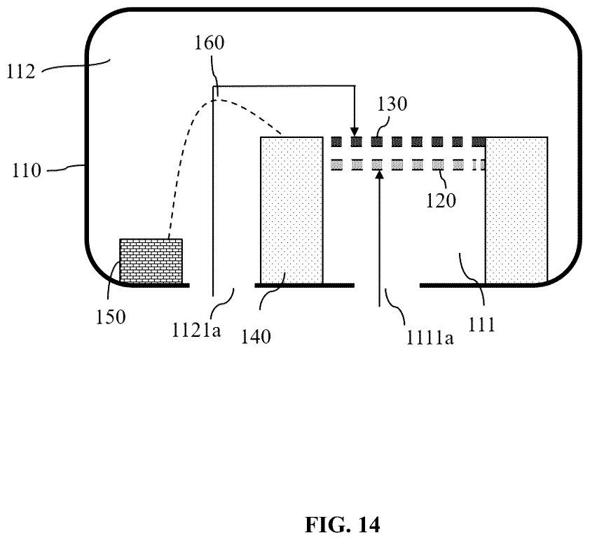

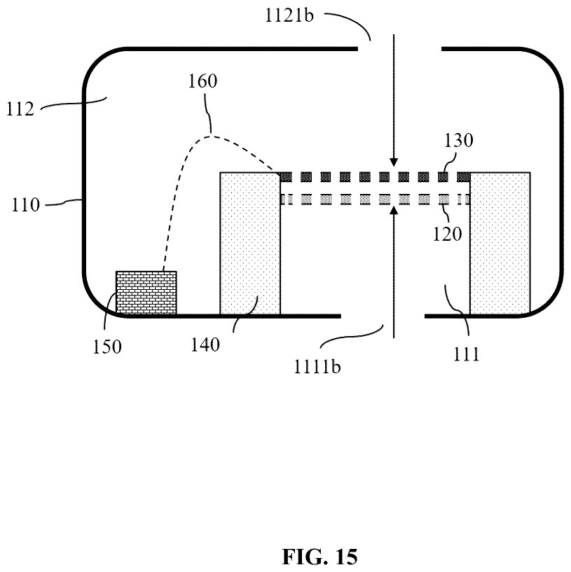

In some embodiments, a first movable electrode 1120 may include a plurality of first movable cantilever beams 1121 fixed at one end. A second movable electrode 1130 may include a plurality of second movable cantilever beams 1131 fixed at one end. The plurality of first movable cantilever beams 1121 and the plurality of second movable cantilever beams 1131 are spaced apart in the first direction to form capacitors. FIG. 13 is a schematic diagram of an exemplary structure of a first movable cantilever beam 1121 and a second movable cantilever beam 1131 according to some embodiments of the present disclosure. As shown in FIG. 12 and FIG. 13, the fixed ends 11210 and the free ends 11211 of the plurality of first movable cantilever beams 1121 are located at opposite ends of the plurality of first movable cantilever beams 1121 in the third direction. The free ends 11311 and the fixed ends 11310 of the plurality of second movable cantilever beams 1131 are located at opposite ends of the plurality of second movable cantilever beams 1131 in the third direction. The plurality of first movable cantilever beams 1121 and the plurality of second movable cantilever beams 1131 are arranged adjacent to each other with a gap in the first direction. For example, as shown in FIG. 12, the fixed ends 11210 of the plurality of first movable cantilever beams 1121 and the free ends 11311 of the plurality of second movable cantilever beams 1131 are arranged adjacently and sequentially in the first direction. The free ends 11211 of the plurality of first movable cantilever beams 1121 and the fixed ends 11310 of the plurality of second movable cantilever beams 1131 are also arranged adjacently and sequentially in the first direction. Since the maximum displacement of each first movable cantilever beam 1121 and each second movable cantilever beam 1131 is located at the free end (i.e., the non-fixed end), and the displacement at the fixed end is minimal, the plurality of first movable cantilever beams 1121 and the plurality of second movable cantilever beams 1131 are spaced apart accordingly, which allows the free end 11211 of each first movable cantilever beam 1121 and the fixed end 11310 of an adjacent second movable cantilever beam 1131 to form a first capacitor, and allows the fixed end 11210 of each first movable cantilever beam 1121 and the free end 11311 of an adjacent second movable cantilever beam 1131 to form a second capacitor. During the vibration of the first movable electrode 1120 and the second movable electrode 1130, a plurality of first capacitors and second capacitors are connected in parallel, thereby enhancing the sensitivity of the microphone 1000.

In some embodiments, to increase the flexibility of the first movable electrode 1120 and the second movable electrode 1130 to increase the vibration amplitudes of the first movable electrode 1120 and the second movable electrode 1130, the width of the first movable electrode 1120 and the width of the second movable electrode 1130 may be in a range of 0.1 μm-30 μm, and the thickness of the first movable electrode 1120 and the thickness of the second movable electrode 1130 may be in a range of 0.1 μm-30 μm.

In some embodiments, when it is desired that the diaphragm 120 has the same sensitivity to the flow of air molecules on the two sides of the diaphragm, i.e., the sound wave signal exhibits the “8” pattern, an area of the third sound guiding hole 8111 may be equal to an area of the fourth sound guiding hole 8121, thereby preventing different flow volumes of air molecules due to a difference between the area of the third sound guiding hole 8111 and the area of the fourth sound guiding hole 8121, which may further result in the diaphragm 120 having different sensitivities to the flow of air molecules on the two sides of the diaphragm.

In some embodiments, when it is desired that the diaphragm 120 not be equally sensitive to the flow of air molecules on the two sides of the diaphragm, i.e., the sound wave signal is directional in nature, the area of the third sound guiding hole may be different from the area of the fourth sound guiding hole. In some embodiments, a ratio of an absolute value of the difference between the area of the third sound guiding hole and the area of the fourth sound guiding hole to the area of the third sound guiding hole may be no less than 10%. In some embodiments, a ratio of the absolute value of the difference between the area of the third sound guiding hole and the area of the fourth sound guiding hole to the area of the fourth sound guiding hole may be no less than 10%.

In some embodiments, the third sound guiding hole 8111 and the fourth sound guiding hole 8121 are respectively provided with acoustic resistance elements corresponding to different levels of acoustic resistance.

The detailed description of the third sound guiding hole 8111 and the fourth sound guiding hole 8121 and their associated element arrangement may be found in the related descriptions of the first sound guiding hole 1111 and the second sound guiding hole 1121.

In some embodiments, the third sound guiding hole 8111 may be configured to form a third acoustic path that allows air to flow to a surface of the movable electrode facing away from the fixed electrode, and the fourth sound guiding hole 8121 may be configured to form a fourth acoustic path that allows air to flow to a surface of the movable electrode facing towards the fixed electrode.

In some embodiments, when it is desired that the diaphragm 120 be equally sensitive to the flow of air molecules on the two sides of the diaphragm, i.e., the sound wave signal exhibits the “8” pattern, a path length of the third acoustic path may be equal to a path length of the fourth acoustic path, thereby preventing a difference between energy attenuation of the air molecules from the third sound guiding hole 8111 to the diaphragm 120 and energy attenuation of the air molecules from the fourth sound guiding hole 8121 to the diaphragm 120 due to the difference between the path length of the third acoustic path and the path length of the fourth acoustic path, which may further result in the different sensitivities of the diaphragm 120 to flow of air molecules on the two sides of the diaphragm.

In some embodiments, when it is desired that the diaphragm 120 not be equally sensitive to the flow of air molecules on the two sides of the diaphragm, i.e., the sound wave signal has directionality, the path length of the third acoustic path may be unequal to the path length of the fourth acoustic path. In some embodiments, a ratio of an absolute value of the difference between the path length of the third acoustic path and the path length of the fourth acoustic path to the path length of the third acoustic path may be no less than 10%. In some embodiments, a ratio of the absolute value of the difference between the path length of the third acoustic path and the path length of the fourth acoustic path to the path length of the fourth acoustic path may be no less than 10%.

In some embodiments, an acoustic delay element may be disposed in the third acoustic path and/or the fourth acoustic path. The acoustic delay element is configured to extend the physical length of the corresponding acoustic path. In some embodiments, the third acoustic path and/or the fourth acoustic path includes at least one bent section.

The detailed description of the third acoustic path and the fourth acoustic path and their associated component arrangements may be found in the related descriptions of the first acoustic path and the second acoustic path.

Beneficial effects that may be brought about by the embodiments of the present disclosure include, but are not limited to: (1) by designing a microporous structure (e.g., the first hole array and the second hole array) on the backplate and the diaphragm, the diaphragm is made to vibrate differently under sound signals of different directions, so as to make the capacitive microphone directional; (2) by designing the diameter of the micro holes of the hole array, the hole spacing between adjacent micro holes, etc., the sound wave can pass through the diaphragm with less loss, so as to improve the sensitivity of the capacitive microphone; (3) by designing the distance between the backplate and the diaphragm or setting the protruding structure between the backplate and the diaphragm, contact between the diaphragm and the backplate during vibration can be avoided; (4) by designing the elastic structure between the diaphragm and the substrate, the connection between the substrate and the diaphragm can be prevented from affecting the vibration of the diaphragm; (5) by designing two backplates (e.g., the first backplate and the second backplate) to form two capacitors (e.g., the first capacitor and the second capacitor) with the diaphragm, the differential signal of the two capacitors can be used to increase the sensitivity and signal-to-noise ratio of the capacitive microphone; (6) by designing the fixed electrode and/or the movable electrode in the capacitive microphone, the movable electrode produces different vibrations under sound signals in different directions, so that the capacitive microphone has directionality.

It should be noted that descriptions of FIG. 1-FIG. 13 are exemplary descriptions only and do not constitute limitations to the present disclosure. For a person of ordinary skill in the art, a wide variety of variations and modifications may be made in accordance with the guidance of the present disclosure. Different embodiments may have different beneficial effects, and in different embodiments, the beneficial effects may be any one or more of the foregoing or any other beneficial effect that may be obtained.

The basic concepts are described above. Obviously, for those skilled in the art, the above-detailed disclosure is only an example and does not constitute a limitation to the present disclosure. Although not expressly stated here, those skilled in the art may make various modifications, improvements, and corrections to the present disclosure. Such modifications, improvements, and corrections are suggested in the present disclosure, so such modifications, improvements, and corrections still belong to the spirit and scope of the exemplary embodiments of the present disclosure.

Meanwhile, the present disclosure uses specific words to describe the embodiments of the present disclosure. For example, “one embodiment,” “an embodiment,” and/or “some embodiments|refer to a certain feature, structure, or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This manner of disclosure does not, however, imply that the subject matters of the disclosure require more features than are recited in the claims. Rather, claimed subject matters may lie in less than all features of a single foregoing disclosed embodiment.

Some embodiments use numbers to describe the count of components, and attributes, and it should be understood that such numbers used in the description of the embodiments are modified in some examples by the modifiers “about,” “approximately,” or “generally.” Unless otherwise stated, “about,” “approximately,” or “generally” indicates that a variation of +20% is permitted. Accordingly, in some embodiments, the numerical parameters used in the present disclosure and claims are approximations, which may change depending on the desired characteristics of the individual embodiment. In some embodiments, the numeric parameters should be considered with the specified significant figures and be rounded to a general number of decimal places. Although the numerical domains and parameters configured to confirm the breadth of their ranges in some embodiments of the present disclosure are approximations, in specific embodiments such values are set as precisely as possible within the feasible range

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A capacitive microphone, comprising:
a diaphragm, wherein the diaphragm is provided with a first hole array that allows airflow to pass through; and
a backplate, wherein the backplate is provided with a second hole array that allows airflow to pass through, and the diaphragm and the backplate are spaced apart from each other to form a capacitor.

2. The capacitive microphone of claim 1, wherein
a diameter of each hole of the first hole array on the diaphragm is in a range of 5 μm to 50 μm; or
a diameter of each hole of the second hole array on the backplate is in a range of 5 μm to 50 μm.

3. The capacitive microphone of claim 1, wherein
a spacing between two adjacent holes of the first hole array on the diaphragm is in a range of 0.1 μm to 50 μm; or
a spacing between two adjacent holes of the second hole array on the backplate is in a range of 0.1 μm to 50 μm.

4. The capacitive microphone of claim 1, wherein a distance between the backplate and the diaphragm is in a range of 0.5 μm to 20 μm.

5. (canceled)

6. The capacitive microphone of claim 1, further comprising:
a substrate, wherein a perimeter side of the diaphragm is elastically connected to the substrate.

7. The capacitive microphone of claim 6, wherein the perimeter side of the diaphragm is elastically connected to the substrate through a plurality of symmetrically distributed elastic structures.

8. The capacitive microphone of claim 6, wherein a perimeter side of the backplate is rigidly connected to the substrate.

9. The capacitive microphone of claim 1, wherein a protruding structure is disposed on a surface of the backplate facing the diaphragm or a surface of the diaphragm facing the backplate.

10. The capacitive microphone of claim 1, wherein the backplate includes a conductive layer and an insulating layer, and the conductive layer is located between the insulating layer and the diaphragm.

11. The capacitive microphone of claim 1, wherein the backplate includes a conductive layer and an insulating layer, and the insulating layer is located between the conductive layer and the diaphragm.

12. The capacitive microphone of claim 1, wherein the backplate includes a first backplate and a second backplate disposed on two sides of the diaphragm, respectively;
the diaphragm and the first backplate are spaced apart to form a first capacitor, and the diaphragm and the second backplate are spaced apart to form a second capacitor.

13. The capacitive microphone of claim 1, wherein a thickness of the diaphragm is in a range of 0.1 μm to 10 μm.

14. (canceled)

15. The capacitive microphone of claim 1, further comprising a housing accommodating the diaphragm and the backplate, wherein
the housing is provided with a first sound guiding hole and a second sound guiding hole,
the first sound guiding hole is configured to form a first acoustic path that allows air to flow to a surface of the diaphragm facing away from the backplate, and
the second sound guiding hole is configured to form a second acoustic path that allows air to flow to a surface of the diaphragm facing towards the backplate.

16. The capacitive microphone of claim 15, wherein a path length of the first acoustic path is equal to a path length of the second acoustic path.

17. The capacitive microphone of claim 15, wherein an opening area of the first sound guiding hole is equal to an opening area of the second sound guiding hole.

18. The capacitive microphone of claim 15, wherein a path length of the first acoustic path is not equal to a path length of the second acoustic path;
a ratio of an absolute value of a difference between the path length of the first acoustic path and the path length of the second acoustic path to the path length of the first acoustic path is not less than 10%; or
a ratio of the absolute value of the difference between the path length of the first acoustic path and the path length of the second acoustic path to the path length of the second acoustic path is not less than 10%.

19. The capacitive microphone of claim 15, wherein an area of the first sound guiding hole is not equal to an area of the second sound guiding hole;
a ratio of an absolute value of a difference between the area of the first sound guiding hole and the area of the second sound guiding hole to the area of the first sound guiding hole is not less than 10%; or
a ratio of the absolute value of the difference between the area of the first sound guiding hole and the area of the second sound guiding hole to the area of the second sound guiding hole is not less than 10%.

20. The capacitive microphone of claim 15, wherein the first sound guiding hole and the second sound guiding hole are respectively provided with acoustic resistance elements corresponding to different levels of acoustic resistance.

21. The capacitive microphone of claim 15, wherein an acoustic delay element is disposed in the first acoustic path and/or the second acoustic path, and the acoustic delay element is configured to extend a physical length of the corresponding acoustic path.

22. The capacitive microphone of claim 15, wherein the first acoustic path and/or the second acoustic path includes at least one bent section.

23-39. (canceled)
